(19) United States
(12) Patent Application Publication
(10) Pub. No.: US 2026/0166656 A1
(43) Pub. Date: Jun. 18, 2026

(54) ARTICLE BEARING MACHINE-READABLE CODE IMPARTED COMPLETELY BY LASER MARKING

(71) Applicant: THE PROCTER & GAMBLE COMPANY, Cincinnati, OH (US)

(72) Inventors: Joseph Craig LESTER, Fairfield Township, OH (US); Marc Andrew MAMAK, Mason, OH (US); Matthew Aaron NEUMANN, Montgomery, OH (US); Benjamin Jacob CLARE, Cincinnati, OH (US); Adam James VIEL, Guilford, IN (US)

(21) Appl. No.: 19/422,591

(22) Filed: Dec. 17, 2025

Related U.S. Application Data
(60) Provisional application No. 63/735,375, filed on Dec. 18, 2024.

(51) Int. Cl. B23K 26/40

(52) U.S. Cl. CPC B23K 26/40

(57) ABSTRACT

An article comprising a polymeric surface bearing a machine-readable code formed by laser marking, the code having adjacent lighter and darker areas. A ΔL* between the lighter and darker regions may be equal to or greater than 20; and equal to or less than 80. The code may comprise a two-dimensional barcode exhibiting a grade equal to or greater than 1, based on verification according to ISO/IEC 15415 and/or a one-dimensional barcode exhibiting an overall symbol grade of equal to or greater than 1.5, based on verification according to ISO/IEC 15416.

### CROSS REFERENCE TO RELATED APPLICATIONS

This application claims the benefit, under 35 U.S.C. § 119 (e), to U.S. Provisional Application No. 63/735,375, filed Dec. 18, 2024, the entire disclosure of which is fully incorporated by reference herein.

### BACKGROUND OF THE INVENTION

Currently many, if not most, goods and other articles that move through commerce and/or large transportation channels are accompanied by imprinted machine-readable codes. A machine-readable code may contain a variety of types of information concerning the associated articles. Each entity in the chain of commerce and/or transportation may use the code and information therein for purposes such as product identification, recording sales and purchases, shipment tracking, inventory tracking, etc. Relatively recently, machine-readable codes have been developed, applied and used to cause a computing device, upon reading of the code, to automatically link to a web site, which can, for example, be designed to provide information to the user of the handheld device, concerning a product or service. Codes may be applied directly to articles themselves, and/or to materials physically or associated with articles, goods or services, such as tags, labels, or containers, and may also appear on invoices, receipts, shipping documents, and any other materials that travel with the article or are associated with providing information about goods or services and/or their transfer of ownership, transfer of possession, transportation, receipt, etc.

Examples of machine-readable codes include one-dimensional (1D) barcodes, two-dimensional (2D) barcodes and matrix codes (also sometimes referred to as 2D codes). These codes have been developed, have gained acceptance, and have been used in a variety of formats for a variety of applications. Non-limiting examples of formats include UPC and QR codes.

In some examples of use, a machine-readable code may be imprinted on a label or wrapper that is applied to a container or package containing or otherwise physically associated with the article(s). In some examples, codes may be imprinted via ink printing applied directly to the container, the package, or the articles themselves.

A feature shared by these various code forms is that they are readable by an optical reader. In many examples, this is enabled via inclusion of a pattern of relatively darker-colored bars, squares or other foreground shapes, set against a relatively lighter-colored (often, substantially white) background. Traditionally, optical readers have been configured with a system of one or more photosensors that detect a pattern of light reflected back from the code, when the code is struck by incident light as it is passed in front of the reader. The incident light may be provided by the reader itself. Relatively more recent developments have included a laser as a light source, wherein the laser may be associated with equipment that causes it to scan the imprinted code. Even more recent developments have enabled reading of codes by a digital camera coupled with a computing device (such as a smartphone or other computing device).

Generally, darker-colored shapes or regions of a code absorb a relatively greater quantity of incident light energy, and thereby reflect a relatively lesser quantity of incident light energy. Lighter-colored shapes or regions of a code absorb a relatively lesser quantity of incident light energy, and thereby reflect back a relatively greater quantity of incident light energy. The result is a pattern of reflected light that effectively corresponds with the imprinted code pattern, and is detectable by the reader. The reader generates data concerning the pattern of reflected light, and associated software interprets the encoded information from the generated data.

Various systems of code formats and associated reader systems have become widely accepted and are in use in commerce and transportation, domestically, internationally and worldwide. Commercial and government entities that engage in transactions involving goods, services and/or transportation often have substantial capital investments in code reading equipment and associated hardware and software systems.

Because the encoded information in a machine-readable code is read as a pattern of reflected light, it is important that the pattern accurately reflect the desired information. If the printing or other marking of a code has poor quality, this can cause the code to fail to accurately and/or completely reflect the desired information. Thus, it is important that the printing or other marking of the code, and the features thereof, be sufficiently clear, sharp and accurately positioned, and that the contrast between the light and dark regions be sufficiently substantial. For this reason, in many examples, codes are imprinted as a pattern of relatively darker-colored bars, squares, etc. against a relatively lighter-colored background, and it is desired that the printing quality be clear, sharp and accurate in positioning of features of the code. Substantially black-colored foreground code elements imprinted against a substantially white background have proven to be the most reliable color combination, most easily read by an optical reader.

Internationally accepted standards have been promulgated by the International Organization for Standardization (ISO) and are in use for assessing the quality of imprinted or otherwise marked codes intended to be machine-readable codes, for grading the quality thereof. If, for example, the producer or seller of goods applies code markings that have defects such that they do not grade to a required level according to such standards, in many commercial circumstances this can be cause for buyers or recipients of the goods to reject them, or impose other penalties upon suppliers of the defectively-coded goods. In effect, goods associated with defectively imprinted codes are deemed unlabeled or mislabeled, for purposes of commercial transactions. This is because use of machine-readable codes and associated reading equipment has enabled substantial efficiencies in the recording of information concerning coded goods as they move through commerce. Commercial entities rely upon these efficiencies. Defective code marking can compromise these efficiencies and introduce substantial inefficiencies.

Recently, advances in uses of lasers have made it possible to imprint text and/or decorative information directly onto surfaces of articles, such as, for example, surfaces of polymer materials from which containers are made. Typically, in laser marking/imprinting, a pulsed laser beam is controllably swept in a desired pattern across the surface of the article. A pulsed laser marking system may be configured such that, as each laser beam pulse impacts the surface, the energy delivered thereby causes a localized alteration in the material at or proximate the surface, and associated visible darkening, in the form of a tiny spot. The material forming the article or surface thereof to be marked may be formulated with suitable additives to enhance the effect. The laser marking system may be configured and controlled such that the sweep pattern of the pulsing laser effects a pattern of these spots on the article, that, as a whole, appears to the naked eye as the desired text, decorative image, etc. For purposes of human visual perception, the spots function in a manner similar to that of pixels of a digital/pixelated image. Further, it has been learned that satisfactory machine-readable codes may be imprinted via laser marking, on surfaces of polymeric materials that are substantially white or relatively light-colored, and substantially opaque.

The use of laser marking/imprinting systems to mark articles holds promise for at least partially eliminating processing and material costs associated with producing and applying pre-printed labels or wrappers to product containers, and is an efficient alternative to direct ink printing. In addition, for containers made of recyclable polymeric materials, use of laser marking/imprinting complements the potential for reducing contaminants (labels, adhesives, inks, pigments, etc.) that complicate or impair recyclability.

It has been learned that laser marking/imprinting systems and processes may be used successfully to mark/imprint machine-readable codes directly onto surfaces constituted by various types of polymer materials wherein the polymer materials are sufficiently pigmented so as to be substantially white (i.e., having CIELAB values wherein the L* value is, e.g., greater than 80, and a* and b* values are each relatively near 0), and have low translucency or are substantially opaque.

Darker-colored materials, however, may not sufficiently reflect incident light so as to provide sufficient contrast between unmarked areas and marked areas of the desired code pattern. More translucent or transparent materials can be difficult to laser mark because they allow incident light energy to diffuse therewithin and/or to substantially pass therethrough, rather than be absorbed in a localized manner proximate the point of incidence so as to effect physical and/or chemical alteration of the material as a result. Further, even if they can be marked with the encoded information-containing shapes of a machine code, translucent materials by themselves they may not provide sufficient contrast between unmarked areas and the marked areas of the desired code pattern, because incident light is not sufficiently reflected back from unmarked regions.

For these reasons, to date, labels or wrappers bearing pre-printed machine-readable codes have been applied to articles having surfaces constituted of darker-colored and/or translucent materials. These approaches, however, necessitate additional materials and process steps to effect marking with machine-readable codes, and they complicate or impair recyclability of the polymeric material(s) constituting the articles, by adding contaminants.

To date the art has not developed to enable reliable laser-imprinting of machine-readable codes of satisfactory quality on surfaces of polymeric materials that are pigmented or otherwise colored to have relatively darker colors, or surfaces of polymeric materials that are translucent or transparent. However, darker container materials and/or translucent container materials may be desired by a producer of goods for a variety of functional and/or esthetic reasons.

Accordingly, for purposes of further reducing the need for applied labels or ink-imprinting, opportunity remains for adaptation of laser marking technology for use in applying machine-readable codes to surfaces of polymer materials having a variety of non-white and darker colors and/or relatively higher levels of translucency.

### BRIEF DESCRIPTION OF THE DRAWINGS

FIG. 1 depicts an example of an article imprinted with an alphanumeric character formed by a pattern of marks in a grid.

FIG. 2A is a two-dimensional schematic view of an example of a lasing marking system.

FIG. 2B is a two-dimensional schematic view of an example of positioning an article having a curving surface (shown in cross section) for marking, with respect to a focal plane.

FIG. 3 depicts an example of a grid wherein the locations in adjacent parallel rows are stacked.

FIG. 4 depicts an example of a grid wherein the locations in adjacent parallel rows are offset.

FIG. 5 schematically depicts an example of an alphanumeric character formed by marks in a grid.

FIG. 6A depicts an example of an alphanumeric character formed by marks in a grid.

FIG. 6B depicts an example of an alphanumeric character formed by marks effected via a prior art process.

FIG. 7 is an illustration of marks and voids effected as a result of packets of information sent to a laser controller according to the present disclosure.

FIG. 8 is an illustration of marks and voids effected as a result of packets of information sent to a laser controller according to the present disclosure.

FIG. 9 is an illustration of marks and voids effected as a result of packets of information sent to a laser controller according to the present disclosure.

FIG. 10 is an illustration of marks and voids effected as a result of packets of information sent to a laser controller according to the present disclosure.

FIGS. 11 and 12 depict examples of a portion of a grid wherein repeat distances are the same for rows and columns of locations within the grid, shown with marks imprinted at particular locations and voids in the remaining locations.

FIGS. 13 and 14 depict examples of a portion of a grid wherein repeat distances differ for rows and columns of locations within the grid, shown with marks imprinted at particular locations and voids in the remaining locations.

FIGS. 15 and 16 depict further examples of a portion of a grid wherein repeat distances differ for rows and columns of locations within the grid (in a differing respect from those shown in FIGS. 17 and 18), shown with marks imprinted at particular locations and voids in the remaining locations.

FIGS. 17 and 18 depict further examples of portions of grids wherein repeat distances differ for rows and columns of locations within the grid, shown in differing orientations.

FIGS. 19 and 20 depict further examples of portions of grids wherein repeat distances differ for rows and columns of locations within the grid, shown in differing orientations.

FIGS. 21 and 22 depict further examples of portions of grids wherein repeat distances differ for rows and columns of locations within the grid, shown in differing orientations.

FIG. 23 depicts an example of an arrangement of text, circumscribed by two possible grid outlines.

FIG. 24 depicts an example of an arrangement of text, circumscribed by a possible grid outline.

FIG. 25 depicts at close range a number of grid locations within a rectangular outline, with some of the locations reflecting marks and some reflecting voids.

FIG. 26 depicts at close range a number of grid locations within a conforming outline, with all of the locations reflecting marks.

FIG. 27 depicts a portion of a stacked grid reflecting markings at some locations.

FIGS. 28A-28D illustrate examples of imprinting an alphanumeric character via analog means (FIG. 28A) and via laser marking along grid patterns in varying arrangements (FIGS. 28B-28D).

FIGS. 29A-29D illustrate the examples shown in FIGS. 28A-28D, respectively, reduced in size to approximate 16 point.

FIG. 30 depicts a portion of an offset grid reflecting markings at some locations.

FIGS. 31A-31C depict various non-limiting examples of machine-readable codes.

### DESCRIPTION OF EMBODIMENTS

### Definitions

“Article,” as used herein refers to an individual object such as an object for consumer usage, such as a container suitable for containing materials or compositions. The article may be a container, non-limiting examples of which include bottles, tubes, films, laminates, bags, wraps, drums, jars, cups, caps, and the like. The compositions contained in such containers may be any of a variety of compositions including, but not limited to detergents (e.g., laundry detergent, fabric softener, dish care, skin and hair care), beverages, powders, paper (e.g., tissues, wipes), diapers, beauty care compositions (e.g., cosmetics, lotions), medicinal, oral care (e.g., toothpaste, mouth wash), and the like. Containers may be used to store, transport, and/or dispense the materials and/or compositions contained therein. An article can be made of any a variety of common materials including; PET, PETG, HDPE, PP, PVOH, LDPE, LLDPE, steel, glass, aluminum, cellulose, pulp, paper, etc.

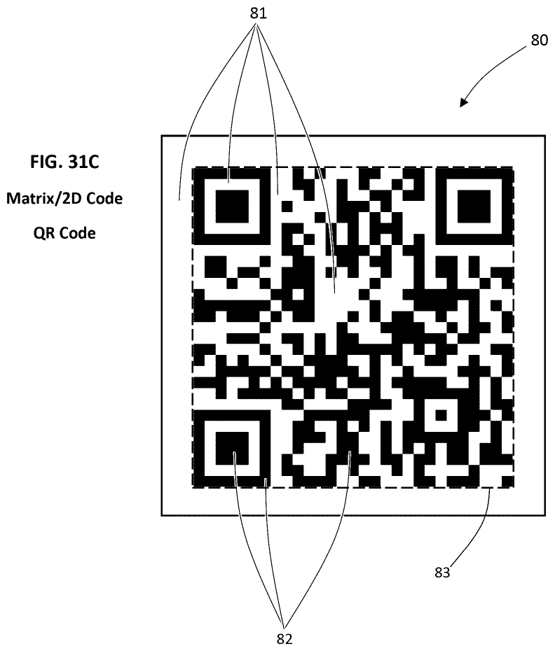

A “machine-readable code” includes a marking applied to an article surface via any means of imprinting or marking, that results in a visible, ordered arrangement of relatively visibly darker-colored bars, squares or other shapes, arranged against a relatively lighter-colored background, wherein the arrangement of darker-colored shapes contains encoded information that may be detected by a suitably-configured optical reader. Non-limiting examples include barcodes such as but not limited to linear or 1-dimensional (1D) barcodes (for example, UPC codes and EAN codes; an example of a UPC barcode is depicted in FIG. 31A); 2-dimensional (2D) barcodes (for example, Codablock codes; stacked barcodes and post codes; an example of a post code is depicted in FIG. 31B); and matrix codes or 2D codes (for example, QR codes; an example is depicted in FIG. 31C).) Although many examples of machine-readable codes in current use have the encoded information contained in relatively darker-colored shapes against a relatively lighter-colored background, it is contemplated that examples of codes and suitably-configured, associated optical readers may be adapted, wherein the encoded information is contained in relatively lighter-colored shapes, set against a relatively darker-colored background. The readability of a code is provided via a suitable contrast between lighter-colored areas and darker-colored areas, and suitably sharp delineation between the two.

Reference is made herein to CIELAB values, and the L*, a* and b* values thereof, of a material surface. CIELAB values of a material surface (other than one that is marked with a machine-readable code, which is discussed separately, below) may be measured via any standardized, machine and/or computer-assisted technique and equipment adapted for such measurement. Equipment and computer software/systems adapted for measuring CIELAB values is known in the art and is readily available.

Herein the term “predominantly,” when referring to a component included in a composition of a material, means that the component constitutes a weight majority of the composition.

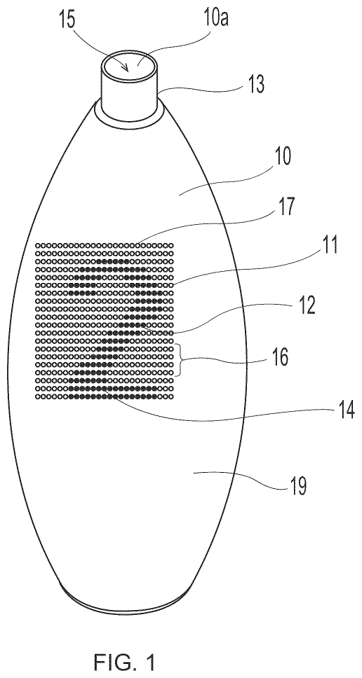

FIG. 1 schematically depicts an article 10 having an image 17 of an alphanumeric character formed by laser marks occupying locations within a grid 16. The image 17 can be consumer readable, machine-readable or both. Image 17 can be, for example, an alphanumeric character, a company logo, a drawing, artwork, UPC or QR codes, and the like. In this instance, the marked locations 12 make up an alphanumeric character 14, which in this case is the number two, “2”. The unmarked locations 11 in the grid 16 are shown for illustration purposes only and do not appear on the final marked article 10. Article 10 is shown as a container and has an opening 10a and a neck 13 that provides access to the interior space 15.

An article according to the present disclosure may be formed of glass, a ceramic, a metal, a single thermoplastic polymer material, a non-thermoplastic polymer material, a cellulosic material, or from two or more materials that are different from each other in one or more aspects. The two or more materials may comprise layers within the article. Where the article has different layers, the materials making up each of the layers can be the same or different from any other layer. For example, the article may comprise one or more layers of a thermoplastic resin, selected from the group consisting of polyethylene terephthalate (PET), polyethylene terephthalate glycol (PETG), polystyrene (PS), polycarbonate (PC), polyvinylchloride (PVC), polyethylene naphthalate (PEN), polycyclohexylenedimethylene terephthalate (PCT), glycol-modified PCT copolymer (PCTG), copolyester of cyclohexanedimethanol and terephthalic acid (PCTA), polybutylene terephthalate (PBCT), acrylonitrile styrene (AS), styrene butadiene copolymer (SBC), or a polyolefin, for example one of low-density polyethylene (LDPE), linear low-density polyethylene (LLPDE), high-density polyethylene (HDPE), propylene (PP) and any combinations thereof. The article may also comprise cellulosic materials such as pulp or paper. The cellulosic material may be included with an additional second material which may be a second cellulosic material or may comprise a resin including thermoplastic material or water/solvent borne coating. A glass, metal or ceramic forming an article (for example) may be coated with a coating material that reacts to energy delivered by a laser beam, in a manner that will impart a visible mark to the surface of the article.

Recycled thermoplastic and/or cellulosic materials may also be used, e.g., post-consumer recycled (“PCR”) materials, post-industrial recycled (“PIR”) materials and regrind materials, such as, for example polyethylene terephthalate (PCRPET), high density polyethylene (PCRHDPE), low density polyethylene (PCRLDPE), polyethylene terephthalate (PIRPET) high density polyethylene (PIRHDPE), low density polyethylene (PIRLDPE) and others.

The thermoplastic materials may include monomers derived from renewable resources and/or monomers derived from non-renewable (e.g., petroleum) resources or a combination thereof. For example, the thermoplastic resin may comprise polymers made from bio-derived monomers in whole, or comprise polymers partly made from bio-derived monomers and partly made from petroleum-derived monomers.

Pigments, colorants, and laser absorption additives may be added to the material of the articles contemplated herein. Suitable choice of the laser wavelength in combination with choice of pigments/colorants/additives, may provide for enhanced marking efficacy with respect to one or more of extent of color change/contrast imparted; rapidity of color change/contrast effected; energy required to effect color change/contrast; edge sharpness of laser-effected spots, etc. In cases where increase in contrast or speed of marking is desired, inclusion of such pigments/colorants/additives may facilitate absorption of the laser energy, thereby serving as laser absorption additives. Laser absorption additives can facilitate forming the laser-marks and can make the laser-markings more vivid and more easily read by users and machines, as well as increase the rate at which the article can be marked. Suitable selected laser absorption additives can generally absorb the laser energy specific to the chosen laser wavelength, followed by initiating a color change to the surrounding matrix (via local heating to cause carbonization, foaming, etc.); or the laser absorption additive itself undergoes a chemical or physical change that causes a change in appearance.

Titanium dioxide and carbon black are pigments commonly used to opacify containers to protect the contents from the effects of light. They can also serve as laser absorption additives, depending on the wavelength of the laser being used. Additional examples of laser absorption additives include: titanium dioxide (TiO₂), titanium dioxide coated substrates such as mica, titanium sub-oxides, titanium nitride, zinc oxide, zinc sulfide, cadmium sulfide/selenide, ultramarines, tin oxides, antimony tin oxide (ATO), ATO coated substrates such as mica, Sb₂O₃, indium oxide, indium tin oxide (ITO), doped metal nitrides, metal carbides, metal borides, tungsten oxides, doped tungsten oxides including hydrogen, cesium, sodium, and potassium tungsten bronzes, carbon black, graphene, graphitic carbon, graphene oxide, nano-graphite, lanthanum hexaboride, bismuth oxide, bismuth vanadate, iron oxides including hematite, magnetite and goethite, iron oxide coated substrates such as mica, cobalt and chromium oxides, mixed metal oxides, metal phosphates including copper phosphate, effect pigments, zero valent metals such as iron, aluminum, tungsten and copper having particle size distributions across the nano and micron ranges, pearlescent pigments, organic pigments including anthanthrone, anthraquinone, Benzimidazolone, BONA lakes, Mono and Diazo chemistries, pyrdiketopyrrolopyrrole (DPP), napthol chemistries, perylene, perinone, Quinacridone, Quinophthalone, phthalocyanines, indanthrone, isoindoline, metal complexes, napthols, and combinations thereof. In some examples, additives may be available or may be included in a prepared pre-mix in the form of very fine particles of the additive material dispersed in a suitable carrier. In some examples it may be desired that the carrier be miscible in melt with the desired polymer resin. In some examples, a polyethylene wax may be used as the carrier.

For the purpose of striking a balance between machine-readable code marking efficacy and minimization of loading for purposes of maximizing recyclability, for marking machine-readable codes on surfaces constituted substantially or entirely of PET, it may be desired that a laser absorption additive thereto comprise one or both of aluminum and antimony tin oxide (ATO). It has been learned that these additives may be particularly effective for absorbing laser energy (a) to effect localized heating, to effect, in turn, foaming or altered crystallization (for lightening), and alternatively, (b) to undergo carbonization or reduction and thereby darkening in color in reaction to absorption of laser energy of suitable wavelength. They also may be advantageous as additives to polymers used to make translucent or transparent articles (for example, clear bottles) because they are relatively neutral in color and therefore do not impart substantial coloration or haze when added to constituent polymeric resins relatively small but still effective, quantities. Average or mean particle size of 200 nanometers or less, or alternatively, 1 micrometer or more, may be desired, to minimize creation of cloudiness or haze. (Without intending to be bound by theory, it is believed that these size preferences relate to the range of wavelengths of visible light passing through the polymer material.) Average or mean particle size is often provided by suppliers of additives or additive pre-mix preparations.

Without intending to be bound by theory, it is believed one or more of the other additives listed above may serve these purposes as well. In some examples in which a translucent or transparent article is desired other alternatives may include tungsten oxide, titanium nitride, indium tin oxide, indium oxide, and carbon black. In some examples, TiO₂ may be preferred as an additive for materials that are desired to be translucent or even opaque because it undergoes reduction to effect darkening at a first laser selection and/or setting, but may enhance lightening by foaming and/or altered crystallization at a second laser selection and/or setting, due to its substantially white color and opacifying effect on polymer resins in which it is included.

Examples of laser marking laser absorption additives that may be suitable are those commonly sold under the tradename IRIOTEC, by Merck KGaA of Darmstadt, Germany, and LASERSAFE by Eckart GmbH, Hartenstein, Germany (aluminum particles in PE wax).

### Pulsed Laser and Pulsed Laser System

A pulsed laser such as a short-pulsed laser may be used to mark the articles according to the present disclosure. Lasers for use in the present disclosure are commercially available and include lasers having nano-, pico-, and femto-second pulse duration. Short-pulsed lasers can emit pulses applied at relatively high energy-densities and high repetition rates, which are important to allow laser-marking at relatively high speed. For purposes herein, it may be desirable that the pulsed laser utilized be capable of pulsing at a repetition rate of at least 100 kHz, preferably at least 200 kHz, more preferably at least 500 kHz, and even more preferably at least 1000 kHz, or even 3,000 kHz.

Impingement of a suitably focused laser beam pulse upon an article surface may effect a mark visible as a lightening or darkening of material at the impingement site, visibly contrasting with adjacent unaffected areas, via ablation, altered crystallization, annealing, bleaching, carbonization, chemical change, curing, etching, foaming, melting, oxidation, phase change, pyrolysis, and/or reduction, and combinations thereof, at and/or proximate the surface, at and/or proximate the impingement site.

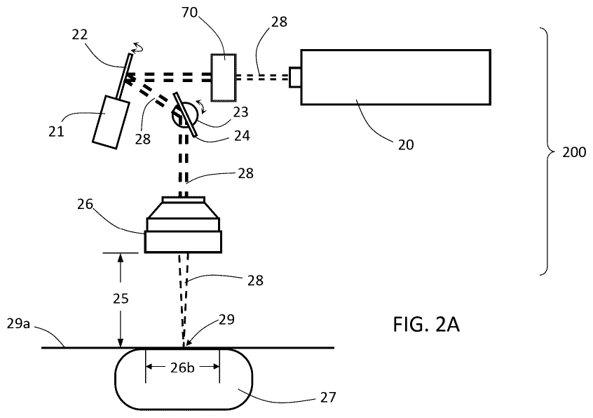

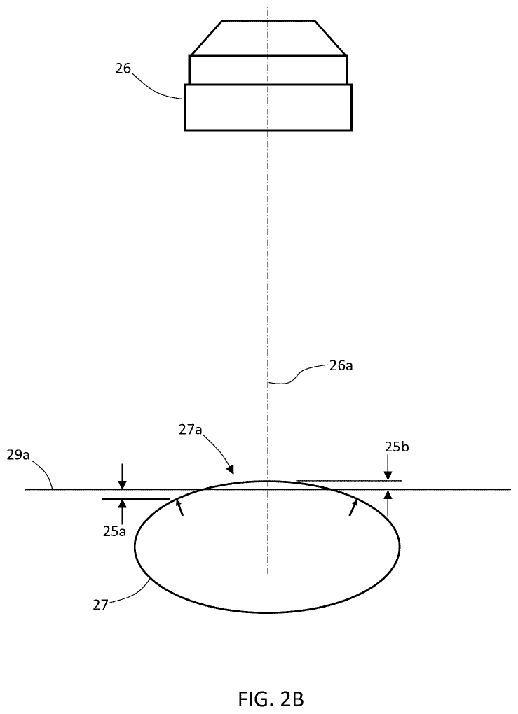

Any suitable pulsed laser can be used to mark an article 10. FIG. 2A schematically depicts an example of a pulsed laser system 200 comprising a pulsed laser 20 useful for marking an article surface. The pulsed laser system 200 includes a pulsed laser 20 which may be any laser capable of generating sufficient energy to mark the articles, such as, for example, a pulsed UV laser, having power in the range of 1 W to 200 W, and a laser light wavelength of 355 nanometers; or an IR pulsed marking laser, having an average power in the range of at least 100 W to 300 W, or to 500 W, 1000 W or even 2000 W, and a laser wavelength of 1030 or 1064 nanometers (infrared (IR) range); or a pulsed green laser having a laser light wavelength of 515 or 532 nanometers and an average power range of 10 W to 1000 W. In some examples, a UV laser may be preferred. Without intending to be bound by theory, it is believed that a laser emitting a beam of a wavelength in the infrared (IR) range, used to mark a surface constituted of polymer material containing suitable additive(s), can be effective for both lightening (operating at a first fluence effective to effect foaming and/or altered crystallization), and darkening (operating at a second fluence effective to effect reduction of the additive material, or alternatively, carbonization). It is believed, alternatively, that lasers emitting a beam of a wavelength in the green or ultraviolet (UV) ranges can be used to effect lightening by bleaching, foaming or crystallization (operating at a first fluence), and effect darkening by reduction of an additive material (operating at a second fluence).

For purposes of effecting rapid, clear, sharply-defined marking, it may be desired to utilize a laser of highest average power that is obtainable, recognizing that the power values of pulsed lasers available in the market are increasing with passage of time and advances in technology. Examples of suitable lasers are available from various suppliers, including an IPG ULPN-355-10-1-3-M marker or YLPN-1-1x350-50-3M MOPA module, available from IPG Photonics of Oxford, MA, United States. Other makes and types of lasers are also possible and different power ranges and settings may be used. The pulsed laser system can include optics that can be used to direct the laser beam, and/or to modify the laser beam such as by changing the energy density and/or spot size of the laser beam 28, as desired.

Frequency or Repetition Rate, measured in Hz, is the number of laser pulses a single laser can deliver in a second. For instance, a 1 MHz laser delivers 1,000,000 pulses per second where a 100 kHz repetition rate laser delivers 100,000 pulses per second. Repetition rate can be important for processing a laser-marked print assignment in a short amount of time (i.e., high-speed laser marking). Within the limits of the speed capability of the gating system, pulse frequency correlates (inversely) to the time required to mark a given row or column of a grid for a particular job almost linearly.

Pulse Energy is the amount of energy a single laser pulse contains and is typically measured in μJ or mJ. Typically, pulse energy is in the range of 5 μJ to 2000 μJ (2 mJ), preferably in the range of 7 μJ-1000 μJ, and more preferably 10 μJ-300 μJ. The average power of the laser, then, is given as the pulse energy times the repetition rate:

Average power=pulse energy (J)*rep rate (Hz or 1/sec).

Peak power is equal to pulse energy divided by pulse duration, and pulse duration can be less than 100 nanoseconds, less than 50 nanoseconds, less than 20 nanoseconds, less than 10 nanoseconds, less than 1 nanosecond, less than 500 picoseconds, less than 100 picoseconds, less than 20 picoseconds, less than 800 femtoseconds, less than 500 femtoseconds, less than 200 femtoseconds. Therefore, pulse energy and pulse duration are linearly related to peak power. The relatively shorter pulse durations achievable with nanosecond, picosecond and femtosecond lasers provide for relatively higher peak power which can improve marking effectiveness and sharpness of the effected marks.

In the pulsed laser system 200 schematically depicted in FIG. 2A, the laser 20 emits laser beam 28, which is directed to a beam guidance system which may include an X-Y galvo set. The X-Y galvo set may include X-mirror 22 which is rotated by X-galvo 21 and Y-mirror 24 which is rotated by Y-galvo 23. Where the beam guidance system includes an X-Y galvo set, laser beam 28 is directed to X-mirror 22, is then reflected and redirected by X-mirror 22 to Y-mirror 24. Y-mirror 24 then reflects and redirects beam 28 to lens(es) 26. The X and Y mirrors 22 and 24 are respectively rotated by X- and Y-galvos 21 and 23, which are operated, respectively, to work together to direct the target focus point of laser beam 28 to a location at or proximate to where a desired mark is to be effected on article 27 with a markable surface. If as in some examples the markable surface is planar, it is preferably positioned for marking along or proximate a focal plane 29a. Before laser beam 28 reaches focal plane 29a and article 27, it will pass through one or more focusing lens(es) 26, which focus the beam. The distance from the forwardmost physical edge of the focusing lens 26 to the focal plane 29a is the working distance 25. The focal plane 29a is normal to the optical axis of the focusing lens. The working distance 25 is the distance from the forwardmost physical edge of the lens to the point at which the lens most tightly focuses the beam 28, at target focus point 29, which lies in the focal plane 29a. (Note: The working distance may be close to, but may differ, from the focal length of the lens. The focal length of the lens is a function of the particular lens design, and is typically specified by the lens manufacturer.) In some examples, it may be desired that the lens be a flat-field lens which can provide tight focus of the beam along an extended area (field of view 26b) of a focal plane (i.e., in regions of the focal plane spaced away from the optical axis). In some examples, it may be desired that the lens be an f-theta lens, which provides the function of a flat-field lens, and in addition, causes distance of the laser focus point sweep along the focal plane to have a linear relationship with change of incident angle of the beam striking the lens (known in the art as θ (theta)—the angle between the incident beam direction and the optical axis). Both a flat-field lens and an f-theta lens can facilitate improvement of marking effectiveness over an extended area of a markable surface of an article, by providing tight focus of the beam at regions of the focal plane, within a field of view 26b of the lens, that are distanced from the intersection of the optical axis and the focal plane. The X-Y galvo set is configured to operate to sweep the laser beam within the field of view 26b of the lens along the focal plane 29a.

The combined optics of the pulsed laser system (including the beam guidance system and the lens(es)) may be controlled to sweep the laser beam target focus point across the markable surface of an article along predetermined/programmed paths.

For marking on a desired print area of markable surface that is substantially planar, it may be desirable to position the article such that the desired print area lies substantially within the focal plane, including examples in which the article is being translated on a conveyor. For marking on a desired print area of a markable surface that has contour/curvature, it may be desirable to position the article such that, when the desired print area is approximately or substantially centered about the optical axis, the average distance between the desired print area and the focal plane is as small as possible. This will ensure tightest possible focus of the beam (smallest spot size) on average, on the desired print area. A simpler but still effective approach for ensuring effectively tight focus/small spot size, however, may be to simply position the article for printing such that, when the desired print area is substantially centered about the optical axis, the respective locations of the desired print area of the surface that are, respectively, nearest, and farthest, from the lens, are substantially equidistant from the focal plane (and on either side of it). This latter simpler approach is schematically illustrated in two dimensions in FIG. 2B. In the illustrated example, the article 27 is shown in horizontal cross section. The desired print area 27a on a curving surface of article 27 is bounded at the two smaller arrows in the figure. The article 27 is shown positioned for marking, such that, when the print area 27a is approximately or substantially centered about optical axis 26a of lens 26, distance 25a is approximately or substantially equal to distance 25b. Distance 25a is the distance between the focal plane 29a and the location of the print area 27a that is farthest from the lens 26. Distance 25b is the distance between the focal plane 29a and the location of the print area 27a that is closest to the lens 26. It has been learned that, as focal length is increased to the greater distances contemplated herein, sensitivity of the process to relatively minor deviations of distance of points on a desired print area, from the focal plane, are reduced—in other words, acceptable marking effectiveness is more easily maintained along curving print area surfaces, at greater focal lengths. In any event contemplated herein, however, marks imparted to a curved or contoured surface will vary in size slightly according to distance from the focal plane of portions of the curving surface during marking. At locations on the surface that are in or nearest the focal plane during marking, the laser beam pulses are focused most tightly and the spot sizes will be at their smallest; at locations further removed from the focal plane during marking, the laser beam pulses are less tightly focused and the spot sizes will be relatively larger.

The laser beam target focus point may be caused to sweep across the focal plane, along a first path in a grid in a sweep direction, while emitting (and/or omitting/withholding) beam pulses. The combination of the constant sweep-speed of the laser beam target focus point across the focal plane of the article, also called the constant surface velocity of the laser beam, and the repetition rate of the laser pulses, then, determines the repeat distance of marks along the sweep direction along the focal plane.

Repeat distance×Repetition Rate=Surface Velocity

The pulsed laser system includes a gating system, such that the pulsed laser system may emit beam pulses or series of pulses at the pulse repetition rate of the laser, and alternatively, omit or withhold pulses or series of pulses at the pulse repetition rate of the laser, while the associated guidance system (e.g., X-Y galvo set and suitable lens(es)) causes the beam target focus point to sweep along a selected sweep path across the focal plane at a given location along a grid, thereby imparting marks on the article corresponding to the path, or alternatively, leaving unmarked location(s) (herein, “void(s)”) along the path. The laser beam target focus point may be swept across the focal plane at a constant surface velocity relative the focal plane while the pulsed laser system is emitting and/or omitting/withholding pulses. The surface velocity (sweep speed) is defined above. The beam target focus point may subsequently be controlled to sweep across the focal plane along a second path within the grid, adjacent and parallel to the first path, while emitting (and/or omitting) pulses. The laser beam target focus point may controlled to sweep across the first, second and subsequent paths along the focal plane in the same direction or in alternating directions. For example, the laser beam target focus point may be controlled to sweep across the first path from “left-to-right” and across the subsequent/adjacent path from “right-to-left,” or “up-to-down,” or “down-to-up,” or otherwise, in any other opposite directions of travel.

The energy conveyed by the laser beam must be absorbed by the material at or proximate the surface of the article in the desired print area to enable marking. If a material to be marked is naturally substantially translucent or transparent to a laser beam of a particular wavelength such that a substantial portion of the energy carried by the laser beam substantially passes through it rather than being absorbed at or near the surface, successful marking via lightening or darkening proximate the site of laser beam impingement may be difficult or impossible. For a surface constituted of a suitably-composed material, however, the laser energy may be absorbed by the base material and/or a laser absorption additive therein. The laser may be chosen according to the wavelength of the beam it generates, to coincide with an absorption band, band gap energy, or surface plasmon/plasma resonance frequency in the UV-vis-NIR-IR spectrum of at least one of the article's base material or a laser absorption additive incorporated into the article. For example, pulsed lasers utilizing 355 nm (UV) may be absorbed by TiO₂ added to the article, 532 nm (Green) may be absorbed by precious metal nanoparticles like gold, silver and copper. Other laser wavelengths such as 1030 nm-1064 nm or 9-12 μm (Infrared) may be absorbed by PET which may be the base material of the article. Other pairings of laser wavelengths with base materials or laser absorption additives for the article exist and are contemplated herein.

### Laser Marking

Marking via direction of a laser beam, of suitable wavelength and power, at a markable surface of an article may be accomplished by one or more material-altering processes including but not necessarily limited to any of ablation, altered crystallization, annealing, bleaching, carbonization, change in polymer or molecular conformation, chemical change, curing, etching, foaming, melting, oxidation, phase change, polymerization, pyrolysis, and/or reduction, and combinations thereof, of material at or proximate the markable surface, such that a visible change of coloration in the material is effected proximate the location of laser beam impingement.

Foaming is a process whereby the energy delivered by the laser beam melts and vaporizes a portion of polymer resin material proximate the material surface and the location of laser beam impingement, which creates gas bubbles that become trapped within molten resin. Upon cooling and solidification of the material, a small-celled foam structure proximate the surface is left behind. The foam structure visibly differs in color and/or opacity from adjacent unaffected areas; it reflects light more diffusely, resulting in opacification and visible lightening of the foamed regions. Thus, foaming will generally result in contrasting lighter and/or opacifying markings in the areas marked. This method is most commonly used for materials such as, for example, thermoplastic polymers that can be melted and vaporized, and are relatively medium-toned to dark in color, and in addition or alternatively, are translucent or transparent. “Translucent” as used herein means the material, layer, article, or portion of the article allows visible light to pass therethrough, as perceivable by an ordinary observer; in examples in which the article is a container, it is translucent if an ordinary observer may perceive the presence and/or fill level of content(s) inside the article when viewing the outside of the article under ordinary diffuse/non-direct daylight lighting conditions. “Opaque” as used herein means the material, layer, article, or portion of the article does not allow visible light to pass therethrough, as perceivable by an ordinary observer; in examples in which the article is a container, it is opaque if an ordinary observer cannot perceive the presence and/or fill level of content(s) inside the article when viewing the outside of the article under ordinary diffuse/non-direct lighting daylight conditions.

Carbonization is a process that produces dark contrasts visible on light-colored surfaces, and is commonly used on carbon-containing polymers or bio-polymers or natural materials such as such as leather, wood, cellulosic and cellulosic fiber- or pulp-based materials. When carbonizing a material, the laser beam energy heats the surface of the material (generally to a minimum 100° C.) causing emission of oxygen, hydrogen, or a combination of decomposition products. Carbonizing generally effects dark marks with higher carbon content than the unmarked material, making it candidate process for effecting relatively darker markings on lighter-colored surfaces.

Reduction or oxidation occur when the laser beam energy changes the oxidation state of at least one of the article's components such as a laser absorption additive or opacifying pigment, resulting in a discoloration or color change that is visible as a mark. For example, without intending to be bound by theory, it is believed that the energy delivered by a UV laser beam can promote the reduction of TiO₂ to form a titanium sub-oxide where the oxidation state of titanium has been reduced to less than +4 and whereby this reduction results in a color change from white/colorless to blue, dark blue to black.

There are additional methods of marking an article. For example, annealing is a unique laser process available for metals and other materials; it can also be effected on polymeric materials. In some examples the energy from the laser beam creates an oxidation process at or near the surface of the material, which results in a change of color on the material surface. In some examples lightening occurs from heating, gradual cooling and resulting alteration of crystallization of material proximate the surface.

Staining is another marking process achievable as the result of the chemical reaction created on materials when the energy of a laser beam is applied. Variations in color shades will depend on the compositions of the materials being stained. For example, lighter colored plastic materials can often discolor during the laser etching process, resulting in dark marking from the soot particles produced.

Laser engraving is another process that includes removing material as the workpiece surface is melted and evaporated by the laser beam, which produces an impression in the surface being engraved. Removing material is also sometimes referred to as etching or ablating. Laser etching/engraving/ablating leaves a roughened surface where material has been removed. The roughened surface scatters reflected incident light, which has a visible lightening effect. Laser etching is a process where the laser beam removes the top-most surface of a substrate or coating that was previously applied to the article's substrate. A contrast is produced as a result of the different colors of topcoat and substrate or different topography and texture of the etched region versus the adjacent region. Common materials that are laser marked by way of removing of material include anodized aluminum, coated metals, foils and films, or laminates. The term “etch” as used herein as a noun, refers to the cavity formed when material is removed from a surface. As verbs, the terms “etch” and “etching” refer to the act of removing material from a surface. Etching can be performed mechanically, chemically and thermally (e.g., via laser). Although there is no specific limitation on the maximum or minimum depth of an etch, etching depths are typically in the range of about 0.01 mm to about 2.0 mm, including any depth within the range, such as for example, 0.010 mm, 0.075 mm, 0.100 mm, 0.200 mm, 0.300 mm, 0.400 mm, 0.500 mm, 1.0 mm, 1.5 mm and more, from the unetched surface. The edges of an etched cavity may be marked by elevated boundaries formed of foamed and/or melted/displaced/re-cooled material.

Bleaching (sometimes referred to as “photobleaching” or “fading”) has a lightening effect that is the result of is the photochemical alteration of a chromophore (such as in a pigment or dye) or fluorophore molecule such that its inherent color is permanently lost and/or is unable to fluoresce. This is caused by cleaving of covalent bonds or non-specific reactions between the chromophore/fluorophore and surrounding molecules and can also be effected by absorption of energy from impingement by a laser beam.

It should be noted that the laser marking process leaves physical evidence of its use on the marked article, resulting from localized heating and/or absorption of laser energy, of/by the material constituting the marked surface, in comparison to untreated material surrounding the marked region. In some examples, the base material itself will bear evidence of one or more of heat-induced melting, foaming, altered crystallization, carbonization or chemical change resulting from localized absorption of electromagnetic radiation (light or heat). Where present, an additive to the base material will bear or reflect evidence of one or more of oxidation, reduction, bleaching or other chemical change, effected by absorption of laser energy within a particular range of wavelengths. These effects differ from the effects of treatments including, e.g., printing (in ink or similar composition applied to the surface), mechanical material removal (e.g., machining), chemical etching or molding.

There may be a region around a laser beam impingement spot that may be heated during marking, even where material in that region may not be marked. This “heat-affected zone” can still yield effects such as crystallization, which can impact the appearance and/or performance of the material. Short-pulsed lasers (e.g., nano-second lasers) can impart some heat-affected zone, although substantially less than micro-second pulse or CW type lasers (e.g., CO₂, longer pulse IR lasers, etc.). Pico- and femto-second lasers are often termed “ultra-short pulse” and impart very little heat-affected zone. This capability is helpful to control the thermal effects of the marking.

With respect to marking relatively thin-walled portions of articles, or films, in which one or more polymers (such as, by way of non-limiting example, polyethylene, polypropylene and/or PET) constitute a predominant component of the material to be marked or a proximate underlying material, it may be desirable in some in some circumstances to provide a heat sink proximate the area to be marked, and/or, e.g., proximate a surface of the wall portion or film opposite of the surface to be marked, to prevent residual/excess heat energy, delivered by the laser beam and absorbed by the structure, from causing permanent warping, distortion or other deformation of the material caused by absorption of heat and subsequent slow cooling. Slow cooling from elevated temperatures existing at, e.g., regions of foaming or carbonization, involves dissipation of heat energy through the polymer structure away from the marked area, which can promote or allow for heat-induced plastic deformation in regions proximate the marked area. Providing a heat sink can facilitate rapid removal of heat energy from the marked area, thus rapid cooling, and thereby substantially reduce or prevent such deformation. For example, where an article to be marked is a bottle or other container formed of PET, it may be desirable that the container be filled with an effective heat-absorbing liquid, to a sufficient level that it will be present on the inside surface of the container in the area opposite the outside surface to be marked. In another example involving laser marking of a polymer film, the film may be positioned overlaying and in contact with a heat sink material (which may be a reservoir of a heat-absorbing liquid such as water, or in combination or alternatively, may be a structure formed of an appropriate metal or metal alloy selected for having rapid heat-absorbing/conducting properties, for example, aluminum or an alloy thereof) underlying the area to be marked. In some examples, a container to be marked may be adapted for containing liquidous, semi-liquidous or fluid product (non-limiting examples may include beverage products, liquid detergent products, liquid cleaning products, liquid soaps, shampoos and hair conditioners, liquidous skin care products, etc.). In such examples, it may be desired to mark the container after it has been filled with product, such that the product itself serves as a heat sink to draw residual heat from the container wall and thereby prevent heat-induced deformation. This may be particularly desirable when the product is water-based, since water is a highly-effective heat sink, and is not flammable.

Spot (individual mark) size is an important parameter of laser marking as contemplated herein, and relates to the focused area where the laser beam strikes the markable surface. “Spot size” is the diameter of a substantially round mark. Substantially circular/round spots effected by a beam strike zone on the article may be deemed desirable in most applications for purposes of most effective and rapid marking, sharp contrast, control and precision, but it is possible to effect elliptical spot shapes by control of the laser beam optics relative to the article. Spot size can be modified by focusing or de-focusing the laser beam, but the “fluence” (=energy delivered per unit markable area) within the spot decreases as the spot is enlarged or de-focused. Theoretically, the minimum spot-size achievable with any laser is the wavelength of the laser beam itself. As a practical matter, the minimum spot size achievable with pulsed lasers is ˜7-20 μm. Spot size of the laser markings as contemplated herein may be in the range of from about 10 μm to about 300 μm, preferably from about 20 μm to about 250 μm, more preferably from about 30 μm to about 100 μm, and even more preferably from about 40 μm to about 60 μm. Spot sizes for conventional laser markings for date codes (for example using CO₂ lasers) and the like are typically at a minimum of 250 μm and can exceed 800 μm. If relatively fine detail and/or high resolution are desired, relatively smaller spot sizes are preferable. Conversely, if fine detail and/or high resolution are not a priority, larger spot sizes may be acceptable. However, laser marking typically requires a minimum fluence to effect the desired marks, so balancing pulse energy, pulse duration, pulse overlap and spot size may be important.

Geometry of the mark spacing is a contributor to the cycle time and fluence (or energy per unit area) delivered to an article markable surface. For example, the spacing between marks may be such that the marks do not overlap at all, i.e., have 0% overlap. At 0% overlap, each individual laser pulse is the sole source of the energy delivered to effect each discrete mark. If the laser does not have sufficient pulse energy or peak power to effect a desired mark on the markable surface, then one can decrease the pulse spacing (by adjusting the spacing of locations in the grid) to the point where the spots overlap in either one or both grid column and row directions. Overlapping the spots involves delivering more than one laser beam pulse to an overlap area of the markable surface such that sequential beam pulses each strike the overlap area, delivering higher fluence or energy per unit area in the overlap area.

Pulse spacing is a controllable variable that affects cycle time. If a laser has a fixed repetition rate or pulse frequency, then to achieve the lowest process time (also called cycle time) one would want to spread the pulses out (by increasing either or both the spacing of rows and columns of the grid) as much as possible, while retaining the desired levels of image legibility, appearance quality and/or resolution. In some examples contemplated herein, the pulses and resulting effected marks are non-overlapping.

Pulse duration is the length of time a pulse remains continuously above half its maximum value (peak power). The shorter the pulse duration, the greater is the peak power that can be achieved, under constant average power. This is because average power=pulse energy (J)*rep rate (Hz or 1/sec). Peak power is equal to pulse energy divided by pulse duration. Therefore, when pulse duration is reduced, peak power is increased. Increasing peak power enables faster and/or improved carbonization, foaming, oxidation, reduction, etc. at the markable surface, while reducing pulse duration deceases or eliminates the extent of heat-affected zones outside the direct focus of the beam.

The power output of the laser (and resulting fluence) can be manipulated during marking, such that power varies pulse-to-pulse, to impart a grayscale effect, also known as dithering. Such a process is a known aspect of the raster-process of laser-marking. Without intending to be bound by theory, however, it is believed that such dithering during laser-marking also increases process time, because the pulsed laser system must receive a separate and added signal component for each pulse, to control power level. In examples contemplated herein, the laser pulses are emitted at constant power. Constant power may be maintained while the laser is marking within an entire row or even as the laser marks among rows over the course of the entire marked pattern.

### Grid

As used herein, “grid” or “bitmap grid” means a regularly-spaced, periodic array of discrete locations along a focal plane, at which laser marks on a proximate markable surface of an article may be effected, or not, to collectively form a desired visible image, alphanumeric characters/text, machine-readable code (e.g., bar code, QR code) on the print area. The periodicity of the array includes periodicity in of respective columns and rows of locations in the grid. Following laser marking of a surface, each location of the print surface proximate the corresponding location along the focal plane may bear a laser-effected mark, or be left unmarked, i.e., as a “void.” As discussed herein, the pulsed laser system sweeps the target focus point for the laser beam across the focal plane, while the laser beam pulses are either emitted, or omitted/withheld/diverted inside the laser. A mark is effected on the markable surface when the laser emits a pulse that strikes the surface at a location corresponding with a grid location on the focal plane, and an unmarked location (void) remains as such when the laser system does not emit a pulse that strikes the article surface at a location, as the beam target focus point sweeps over it. The laser beam target focus point may be swept across the focal plane at a constant surface velocity while the repetition rate of the laser is constant, so the periodicity of locations along the focal plane will be regular in the direction along which the laser beam is swept, even though the spacing of marked locations may not be equal, given the possibility of unmarked locations/voids. In the event of unmarked locations/voids, the distance between centers of any marked locations along the same direction (i.e., in the target focus point sweep direction) will be, substantially, an integer (e.g., 2×, 3× or larger) of the smallest distance measured between centers of marks in that direction.

The laser beam target focus point may be swept across the focal plane through the grid, in subsequent, successive, parallel paths along series of locations in the grid. The laser beam target focus point may be swept in the same direction as it is moved from sweep path to adjacent sweep path of the grid (e.g. like the carriage-return on a typewriter, as in a raster process) or may be swept in alternatingly opposition directions as it moves from sweep path to sweep path. A contributor to reducing cycle time includes sweeping the laser beam target focus point in alternating directions as it moves from sweep path to adjacent sweep path. The rows and columns of the grid, respectively, may be generally parallel to one another. The locations in adjacent rows may lie directly above/below one another or may be offset relative to one another, and the locations in adjacent columns may lie directly side-by-side each other or may be offset relative to one another. An offset results in a realignment of the locations between rows.

An alphanumeric character is a letter, other symbol used in written language, or a number. For example, the English language (which uses the Latin alphabet and script) uses letters A through Z including upper case and lower case; numbers are expressed using Arabic numerals 0 to 9. Herein, the term “alphanumeric character” is not limited to any particular language, alphabet, script, style or font. By way of non-limiting example, English; Chinese; Spanish; Portuguese; Italian; Greek; French; German; Japanese; Russian; Arabic; Hindi and other languages; and Latin, Greek and Cyrillic scripts; Chinese logograms; Japanese Katakana; Arabic script; Devanagari script and other alphabets/scripts have different alphanumeric characters that can be printed via use of a pulsed laser system contemplated herein.

The size of a printed, or in the present case marked, alphanumeric character is a feature of its font, with size expressed as “point,” or as abbreviated, “pt.” For alphabetic characters of at least, for example, the Cyrillic, Greek and Latin scripts, among others, the smallest font generally accepted to be readable by consumers, on an imprinted article, is 6 point. Fonts can be increased to very large sizes, but when imprinting a designated print area of a consumer package, for example, larger fonts, e.g., in excess of 20 point, may be deemed impractical because they may be too large to enable imprinting of material containing a desired amount of information within a designated print area.

As previously discussed, the laser-effected marks may be arranged to be non-overlapping, to reduce the number of marks required, and thereby reduce the time required to mark, along a given grid (i.e., cycle time). Cycle time can be further reduced by spacing out the grid locations along either or both of the column spacings or row spacings, however, overly increasing spacing can result in poor legibility and/or poor appearance quality of alphanumeric characters or images constituting the desired printing. Nevertheless, increasing the repeat distance allows for a greater surface velocity of the laser beam sweep across the surface of the article when marking along a sweep path (at a constant pulse repetition rate); and selecting the most efficient sweep direction reduces the number of turnarounds required to mark in a given grid. A balance between most permissible efficiency (i.e., smallest permissible cycle time) and a satisfactory level of legibility/appearance quality/resolution may be struck. Repeat distance may be increased by increasing one or both of column spacing and row spacing of locations in the grid.

For a pattern of marks/voids according to a grid pattern, minimizing the number of turnarounds required to complete the marking/print assignment may in some circumstances have a greater impact on reducing time to mark than increasing the repeat distance (faster surface velocity). While conventional raster marking processes include equal column and row spacings, the present disclosure also contemplates use of a grid having differing column and row spacings. It has further been found that legibility of alphanumeric characters marked by the constant surface velocity (CV) bitmap process contemplated herein can depend on the grid location spacing as a function of the font size of the character(s). The column spacing for typical print assignments that include text constituted by alphanumeric characters is preferably in the range of from about 0.005 mm to about 0.500 mm; more preferably from about 0.010 mm to about 0.200 mm; and even more preferably from about 0.040 mm to about 0.100 mm. The row spacing is preferably in the range of from about 0.010 mm to about 2.0 mm; more preferably from about 0.050 mm to about 0.150 mm; and even more preferably from about 0.060 mm to about 0.075 mm.

When alphanumeric characters desired to be imprinted have a font size within the range of 6 pt to 10 pt, the row spacing may be at least 1.2, preferably 1.5, more preferably 1.7, and even more preferably 2 times the column spacing. When alphanumeric characters desired to be imprinted have a font size within the range of 11 pt to 16 pt, the row spacing may be at least 2, preferably 2.5, more preferably 3, and even more preferably 4 times the row spacing.

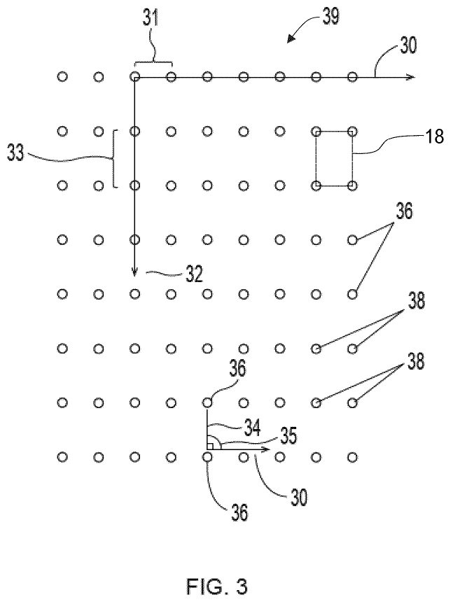

FIGS. 3, 4, and 5 depict various examples of portions of grids as contemplated herein. More specifically, FIG. 3 is an example of a portion of a grid 39, illustrating a possible row direction 30, column direction 32, column spacing 31 and row spacing 33. Potential marking locations 36 are depicted by the empty circles making up the grid. Further, in FIG. 3 the locations 36 among parallel rows 38 are “stacked” when the angle 35 between locations in adjacent row 34 drawn in the column direction between two potential marking locations and the row direction 30 is approximately 90 degrees. In other words, if one uses vectors to connect neighboring marks from the array to form a parallelogram (e.g., unit cell 18), when the interior angles of the parallelogram are approximately 90 degrees, the locations are stacked. When the interior angles of the parallelograms differ from 90 degree (e.g., 120 and 60 degrees), the locations are offset. The column spacing is measured from the center of one location to the center of an adjacent location in the row direction.

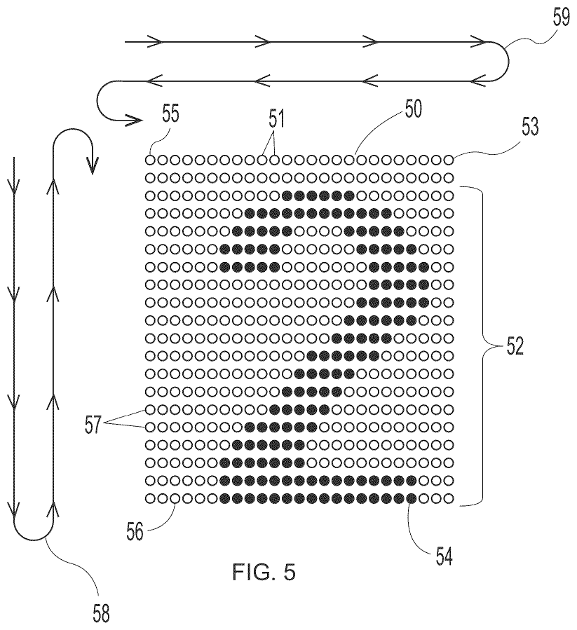

The unit cell of a grid has four symmetrical axes: horizontal, vertical, and two diagonal. The laser marking discussed herein (i.e., the target focus point sweep path) can occur along any of those four axes. The vertical and horizontal directions shown in FIG. 5 are described for simplicity. Again, the laser marking occurs during sweep of the target focus point along a sweep path, then the focus point shift is shifted to an adjacent sweep path, and laser marking occurs during sweep of the target focus point in the opposite direction, an example of which is illustrated in FIG. 5.

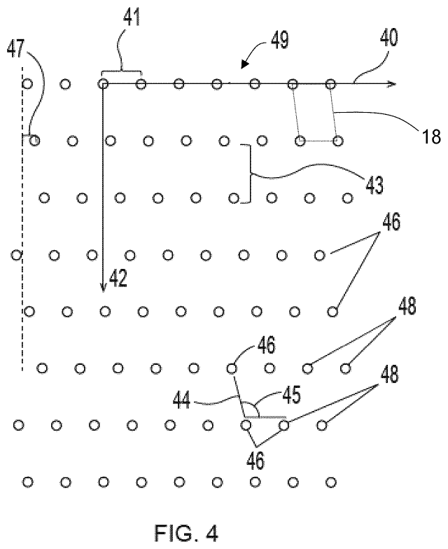

FIG. 4 depicts another example of grid 49 as contemplated herein, showing an offset 44, having an offset distance 47 between adjacent parallel rows 48. Offset 44 is defined by angle 45 between locations 46 in one row 48 and the nearest location 46 in an adjacent row 48, wherein an offset 44 exists when angle 45 is greater than or less than 90 degrees. FIG. 4 further depicts examples of a row direction 40, column spacing 41, column direction 42, and row spacing 43.

FIG. 5 depicts an example of an alphanumeric character 52 formed of marks in a grid 50. The alphanumeric character is the numeral “2” and is constituted by laser marks at locations 54, which are in contrast to unmarked locations (voids) 56. When multiple alphanumeric characters are imprinted, for example, a word, a sentence or a paragraph, the characters sharing the same line of text may also share the same horizontal rows 53 of laser markings. If, for example, the laser beam target focus point is swept horizontally, the laser apparatus will guide the beam to sweep across one row, with beam pulses effecting marks at locations 54 as needed to form individual alphanumeric characters with the desired level of resolution, and leave the necessary number of unmarked locations 56 between characters, to form a row with markings effective to constitute a plurality of characters for that row. By this method, marks to form characters, words, sentences, and paragraphs can be effected with sufficient numerical densities along the horizontal and vertical directions, to achieve the desired level of legibility and quality of appearance.

With respect to FIG. 5, horizontal rows 53 and vertical columns 55 define grid 50.

If the beam target focus point sweeps the grid in the horizontal direction 59, the distance 51 between centers of marked or unmarked locations (54 or 56) in horizontal rows 53 defines the repeat distance, and the distance 57 between centers of marked and unmarked locations in vertical columns 55 defines the distance between sweep paths.

Conversely, if the beam target focus point is to sweep the grid in the vertical direction 58, the distance 57 between centers of marked or unmarked locations (54 or 56) in vertical columns 53 defines the repeat distance, and the distance 51 between centers of marked and unmarked locations in horizontal rows 53 defines the distance between sweep paths.

In the example illustrated, the marked locations 54 may be marked in the horizontal direction 59 (via horizontal sweep of the beam target focus point, row-by-row), or the vertical direction 58 (via vertical sweep of the beam target focus point, column-by-column). More specifically, when marking in the horizontal direction 59, the laser beam target focus point sweeps across a horizontal row 53 either marking, or leaving an unmarked void, at each location (54 and 56, respectively). Then, the laser beam target focus point moves down or up to the next sweep path and begins sweeping across another row above or below the row previously marked. Conversely, when marking in the vertical direction 58 the laser beam target focus point sweeps up or down a vertical column 55 either marking, or leaving an unmarked void, at each location (54 and 56, respectively). Then the laser moves across to the next sweep path and begins traveling up or down a vertical column adjacent the vertical column previously marked.

The aspect ratio of an alphanumeric character is the ratio of its height to its width, as viewed in normal reading orientation. The aspect ratio of the imprinted number “2” shown in FIG. 5 is greater than 1 because its height is greater than its width. In the example shown in FIG. 5, one can see that sweeping the beam to effect marks to imprint the number “2” as shown, in the vertical direction 58, would require fewer turnarounds than marking in the horizontal direction 59. Thus, marking this character, alone, may be faster when sweeping the laser-beam while marking in the vertical direction 58. However, other factors can be relevant to a decision whether to mark in a horizontal or vertical direction. For example, if the numeral “2” as shown in FIG. 5 is only one character in a sentence or paragraph of text to be imprinted in a larger grid and/or a grid for imprinting a graphic image, the most efficient sweep direction could be different.

A grid 39 may be a stacked grid, as depicted in FIG. 3. In a stacked grid, the locations where the marks may be applied in a first row are directly above the locations in a second row immediately above or below the first row. Said another way, the angle 35 formed between the row-segment connecting a first location along the first row with an adjacent location along the first row and the row-segment connecting the first location with its nearest location along the second row is 90°.

A grid may be an offset grid as depicted in FIG. 4. In the example of an offset grid 49 as shown in FIG. 4, the locations where the marks may be applied in a first row are not directly above the locations in a second row immediately below the first row. Said another way, the angle 45 formed between a first line segment connecting a first location along a first row with an adjacent location along the first row, and a line segment connecting the first location with its nearest location along the second row is greater than or less than 90°.

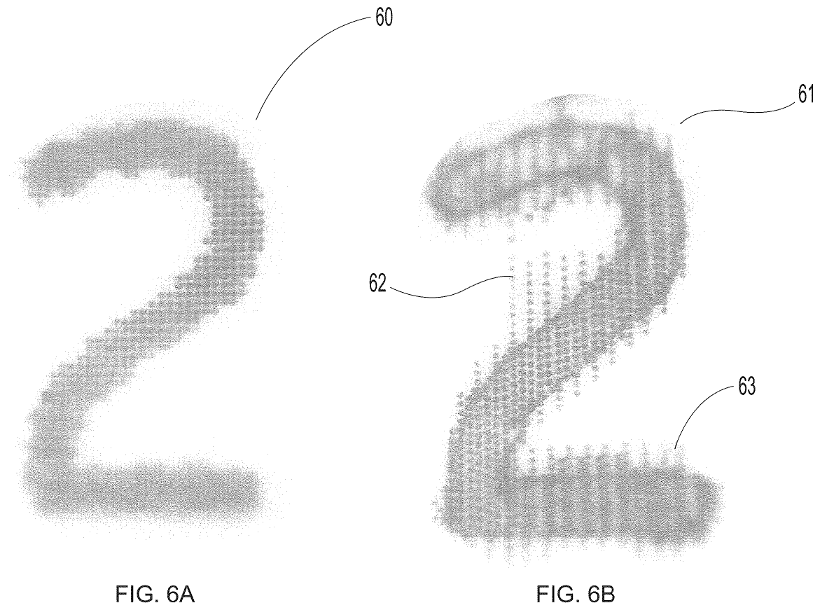

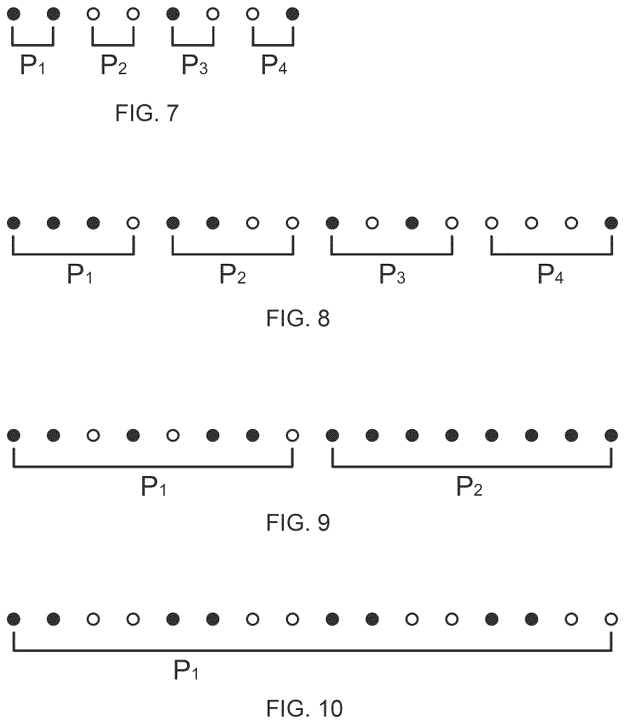

The sweep path direction is chosen relative to the arrangement of locations in a predetermined grid, which is laid out to effect the desired imprinting with desired legibility and appearance quality/resolution. For example, FIG. 6B depicts an example of a “2” made by laser marking wherein the sweep direction is vertical with respect to the marked “2” 61 as ordinarily read/viewed. Depending upon other choices made in laying out the print subject matter and the grid, however, the sweep direction could be horizontal with respect to the marked “2” 61, or diagonal. For an ordinary arrangement (i.e., not stylistically altered in a manner atypical of normal text reading configuration) of alphanumeric text along horizontal rows or columns according to its normal reading orientation, the greater of the row and column spacings may in some examples correspond with an average aspect ratio of the alphanumeric characters. If the average aspect ratio of the alphanumeric characters (average ratio of height to width) is greater than 1, then the greater of the row and column spacings may lie along the vertical direction in many examples, according to the orientation of the alphanumeric characters as they are ordinarily read.

The locations on the grid may be regularly-spaced along respective horizontal and vertical directions, or may be regularly-spaced along directions oblique to the horizontal and vertical directions. In examples where the markable surface of the article 27 to be imprinted is planar and as positioned for laser-marking is proximate to or substantially coincides with the focal plane 29a of the lens 26 (e.g., see FIG. 2A), the marks imparted to the markable surface will substantially coincide with the corresponding grid locations. In examples where the article surface to be printed is contoured/curved (not planar), it may be desired to position the article during marking as described above (and, e.g., see FIG. 2B). (With respect to positioning a planar markable surface “proximate to” a focal plane, “proximate to” means closely enough to the focal plane to provide for effective marking, even though tightest focus of the beam occurs at the focal plane.)

A grid may have differing regions, such that column and row spacings differ between them. Differing regions with differing, discrete print assignments may accommodate or require differing levels of resolution. For example, a first column spacing may be used consistently when marking alphanumeric characters and a second, differing column spacing may be used when marking machine-readable codes such as UPC or QR codes. Similarly, the row spacing may remain the same, or may differ among regions within the grid. The surface (sweep) velocity of the laser beam target focus point and/or the sweep direction (i.e., up/down, side-to-side or diagonal) may also differ among differing regions. The laser marking process contemplated herein, however is typically done at constant speed when the laser beam target focus point is executing a marking sweep. Following the time it reaches the end of one sweep path, the laser beam target focus point is guided by the X-Y galvo set to decelerate from its constant sweep velocity, shift to the next sweep path to be processed, reverse direction, and then accelerate back to the constant velocity to begin processing the next sweep path. The sweep speed (surface velocity) during processing of a sweep path may be consistent throughout the marking of the entire grid, or regions thereof, or may change from region to region. Articles marked with the CV-bitmap grid marking process contemplated herein can be distinguished from articles marked with a vector marking process, by, among other features, the regular periodicity of marks and often by the absence of outlines or “borders” that define the marked area; see for example FIG. 6B, border 63.

FIGS. 6A and 6B illustrate the difference between laser marking via bitmap grid marking with the CV-bitmap process contemplated herein reflected in FIG. 6A, and the prior vector marking process reflected in FIG. 6B. In both cases an alphanumeric character 60 and 61 (i.e., the number “2”) has been formed by marks effected by a pulsed laser. The alphanumeric character 60 (FIG. 6A) is substantially better-defined with cleaner edges, and fewer stray markings. FIG. 6B stands in contrast, with poorly-defined edges and a number of stray markings 62 outside the desired visually-perceivable outline of alphanumeric character 61. The marks of the examples shown in FIGS. 6A and 6B were effected in approximately the same amount of time for each.

The arrangement of any given grid shape and size to be utilized, and the directional orientation and spacing of its rows and columns, to effect imprinting via laser marking on a markable surface of an article, will be affected by the subject article's physical size and shape; the dimensions, shape and surface area of the print area desired; the quantity of alphanumeric text characters and/or graphic content to be imprinted in the print area or region(s) thereof, font choices, judgments concerning desired legibility and appearance quality/resolution; and the layout(s) thereof. The grid will encompass the desired print area.

Configuring a Grid for Printing Alphanumeric Characters and/or Machine-Readable Codes with Reduced Cycle Time

The quantity of alphanumeric characters required to be imprinted within the print area, together with stylistic choices, and desired legibility and quality of appearance, will affect choice of print font style and size, character spacing and line spacing. Additionally, where graphic image(s) are to be imprinted, the level of resolution desired for the image(s) desired must be determined and specified.

Similarly, for laser-mark imprinting of machine-readable codes, the quality of appearance required according to applicable ISO/IEC standards, will drive choices concerning the level of resolution required. (ISO/IEC is a joint abbreviation for the International Organization for Standardization (ISO) and the International Electrotechnical Commission (IEC).)

Working within these conditions, it has been discovered that one may maximize marking/imprinting speed (conversely, minimize required marking/imprinting time, i.e., cycle time) by minimizing each of two variables.

First, one should minimize the total number of potential mark/void locations along rows and columns that must be included in the grid, to produce the print and/or image content desired, with acceptable legibility and appearance quality/resolution.

Second, one should choose the sweep direction as the one that will (1) require the smaller number of turnarounds; and/or (2) require the highest number of emitted pulses (effecting marks) per sweep.

In examples in which alphanumeric text is to be imprinted, the first step may be accomplished by identifying a first direction along which the lowest numeric density of marks (i.e., greatest spacing between centers of marks) is acceptable for satisfactory legibility and appearance quality, and conversely, the direction orthogonal or oblique to the first direction, along which greatest numeric density of marks (i.e., smallest spacing between centers of marks) is needed for satisfactory legibility and appearance quality. This may require experimentation through preparation of sample grids of representatively-sized marks arranged with varying column and row repeat distances, as would reflect the results of an actual laser marking operation following such grids, and subjective judgment reached by viewing the results. (It is also contemplated that appropriate algorithms and/or image analysis equipment and programming may be developed to assist in this task, or even completely perform it using programmed objective criteria, which can reduce or eliminate steps of experimentation and subjective judgment needed.) The determination reached will depend upon factors such as but not limited to, for example, dimensions and content of the desired print area/print assignment; alphanumeric character font style; font size and aspect ratio; character spacing in the reading direction; and line spacing in the direction perpendicular to the reading direction. Non-limiting examples of analytical approaches follow.

Alphanumeric characters are typically formed of combinations of line segments and/or curving segments, that each have a first vector component along a first direction and a secondary vector component along a second direction oblique or perpendicular to the first direction. For a simple example, the Latin script capital letter “N” in Arial font is constituted by two vertical segments each having a single vertical direction vector component, and a single diagonal segment having both a vertical vector component and a horizontal vector component. Because the aggregate total of the lengths of the vertical components is the greatest that can be identified, and because they lie in the vertical direction, the vertical direction is the dominant geometric vector direction.

Without needing to measure every single character in the subject print assignment, one may, with a high level of confidence, identify a direction along which the greatest aggregate number of vector components for all the characters used in the print assignment lies, by e.g., simple visual examination (for, e.g. relatively simple Latin script and fonts). For information conveyed in more complexly-shaped characters, one may (1) measure all of the characters in the script and font chosen; (2) obtain data concerning average frequency of appearance of each character in the chosen language of the text in the print assignment; and (3) calculate a weighted average of first direction vector components and second direction vector components for the characters, and thereby (4) identify the dominant geometric vector direction as the direction in which the greater value exists. In another alternative approach, one may (1) determine the aspect ratios (vertical height/horizontal width) of all of the characters in the alphabet, script and font chosen (assuming the dominant direction will be either vertical or horizontal) and again, (2) obtain data concerning frequency of appearance of each character in the chosen language of the text in the print assignment, and (3) calculate a weighted average aspect ratio for all of the characters. In this latter approach, if the weighted average aspect ratio of the characters is greater than 1, then the aggregate value of the vertical geometric vector components is highly likely to be greater than the aggregate value of the horizontal vector components. Accordingly, the dominant geometric vector direction is highly likely to be vertical.

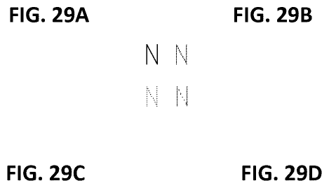

To illustrate, referring to FIG. 28A, suppose that the example single Latin character “N” in non-italicized Arial font, as printed in 12-point pitch, has a vertical height H of 3 mm and a horizontal width W of 2 mm. The character has 3 segments: 2 vertical, and 1 slanted. The 3 segments have 3 respective vertical geometric vector components, the aggregate total length of which is 3× 3 mm=9 mm. Only the 1 slanted segment has a horizontal geometric vector component, the length of which is 1×2 mm=2 mm.

The aspect ratio of the character is 3 mm/2 mm, i.e., 1.5.

Suppose for purposes of discussion that the above analysis and result is substantially representative for all alphanumeric characters in the print assignment. With this assumption, the aggregate total of vertical geometric vector components for all characters will be greater than the aggregate total of horizontal vector components for all characters, and the average character aspect ratio is greater than 1.

As a resulting conclusion, under both analyses, the dominant geometric vector direction will be the vertical direction, and the subordinate geometric vector direction will be the horizontal direction.

Without intending to be bound by theory, it is believed that one may lay out a grid with columns oriented along the dominant geometric vector direction, and rows oriented along a subordinate geometric vector direction perpendicular or oblique to the dominant geometric vector direction. One will thereby have determined that one may space the rows farther apart than the columns, to reduce the number of grid locations, while preserving legibility.

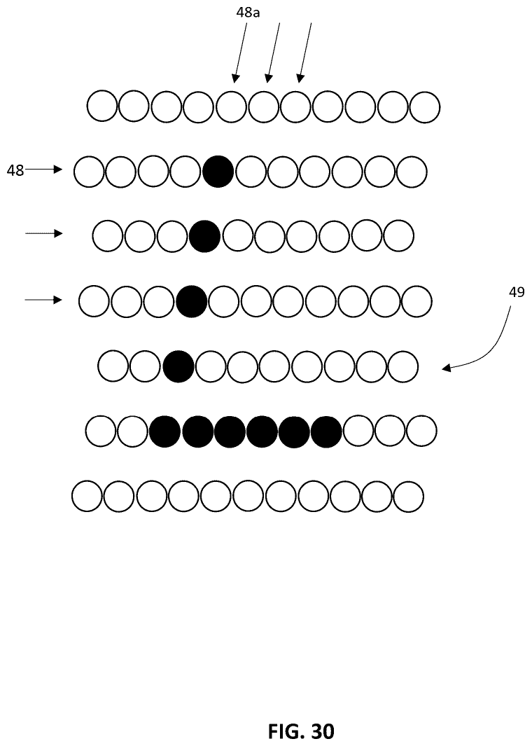

To illustrate in a simple example, FIGS. 28A-28D depict enlarged images of the Latin script capital letter “N” in a simple Arial font, printed in an analog form (FIG. 28A), e.g., via ink printing, and in digital forms, via marks arranged in regularly-spaced locations within a grid (FIGS. 28B-28D). FIGS. 29A-29D depict the same images, respectively, reduced in size to approximately 16 point.

The spacing of the rows and columns of the grid in FIG. 28B is equal. Looking at its reduced-size counterpart in FIG. 29B, it may be appreciated that the letter “N” remains quite legible.

In FIGS. 28C and 29C, half of the grid locations have been removed, by doubling the vertical direction (row) spacing, thereby halving the number of grid locations that would be required to be swept. Looking at FIG. 29C, it may be appreciated that the letter “N” still remains quite legible when substantially reduced in size.

In FIGS. 28D and 29D, half of the grid locations have been removed, by doubling the horizontal direction (column) spacing, thereby, also, halving the number of grid locations that would be required to be swept. Looking at FIG. 29D, however, it may be appreciated that the letter “N” has compromised legibility due to a perceivable loss of visual clarity/distinctiveness of the diagonal leg of the character. Without intending to be bound by theory, it is believed that this is the visual effect of taking away detail along the subordinate direction (in the example of FIG. 28D, the horizontal direction), associated with portions of characters having vector components with the lesser length value. The legibility-compromising effect becomes worse for any particular character, as the dominant direction vector component of a particular character segment becomes smaller, and is most severe when the dominate direction vector component of the particular character segment is zero. For example, in Arial font, the horizontal segments in characters including capitalized Latin characters A, E, F, G, H, L, T and Z, and Arabic numerals 2, 4 and 7, lose needed, distinguishing visual detail, and as a result, the characters/numerals will more quickly become less readily/easily recognizable, as column spacing is increased. It can be appreciated that one would have more flexibility to increase row spacing in these circumstances.

Based on this analysis, it is believed that the direction of largest aggregate total of the geometric vector components of the alphanumeric characters in a print assignment (the dominant geometric vector direction) identifies the direction along which a relatively larger repeat spacing of marks will be acceptable while retaining legibility and desired quality of appearance. One may configure the grid by aligning the orientation of one of either rows or columns to constitute the grid, along the dominant geometric vector direction. Then, one may maximize a first spacing of the other of the rows or columns, i.e., those perpendicular or oblique to the dominant geometric vector direction, to an extent to which minimum legibility/resolution/appearance quality is reached. This maximizes allowable row or column spacing measured along the dominant geometric vector direction.

Then, one may maximize a second spacing of the rows or columns that are aligned with the dominant geometric vector direction, to an extent to which minimum legibility/resolution/appearance quality is reached. This maximizes row or column spacing measured along a direction perpendicular or oblique to the dominant geometric vector direction. However, as reflected by the analysis above, the second spacing will be different, and less than, the first spacing.

This process enables configuration of an efficient grid layout that minimizes the number of locations of a suitable grid that must be swept, and thereby minimizes the number of sweeps required to execute the print assignment.

While alphabet scripts such as, for example, the Latin and Cyrillic scripts, in often-used fonts, may often have dominant geometric vector directions that are vertical, it may be appreciated from the discussion above that the direction of largest aggregate total of vector components of alphanumeric characters in the print assignment (i.e., the dominant geometric vector direction) is not necessarily horizontal or vertical, in all cases. For example, if a predominant portion of the alphanumeric text in the print assignment appears in italics, the largest aggregate total of vector components of alphanumeric characters (along the dominant geometric vector direction) in the print assignment may be diagonal (with respect to horizontal and vertical directions), oriented along the direction of the slant of the italicized material. In such a case, it might be desirable to arrange columns of a grid oriented in such slanted direction. Similarly, it may be appreciated that a subordinate vector direction need not necessarily be perpendicular to the dominant geometric vector direction, but may be otherwise oblique to it.

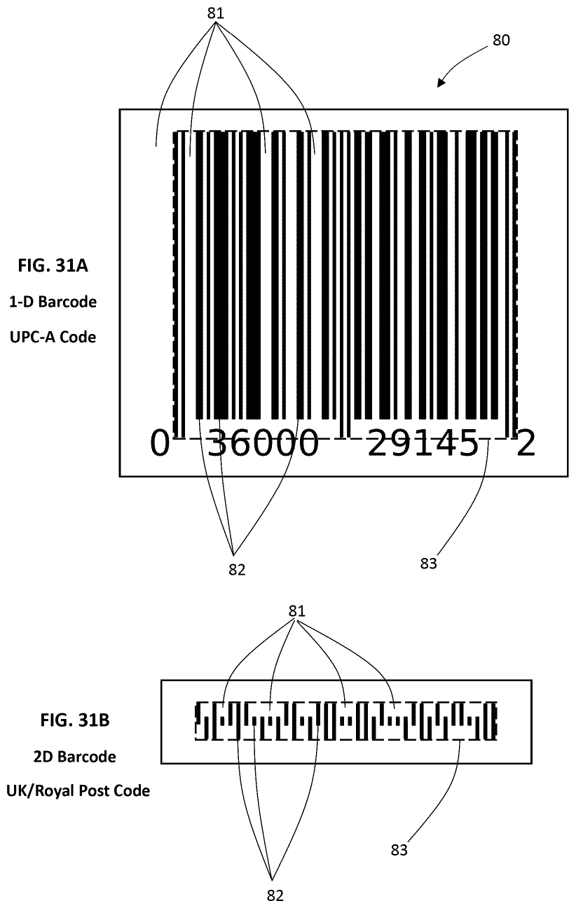

To illustrate, consider the italicized Latin character “L” in simple Arial font. Assuming (without further analysis, for purposes of discussion) that such character “L” is reflective of the dominant and subordinate vector directions of the entire alphabet used and of the subject print assignment (which may be reasonable assumption, since italicization generally slants vertical segments of characters but does not substantially affect directional orientation of horizontal segments, then one might identify the dominant geometric vector direction as that of the slant of the vertically-oriented segments, and the subordinate vector direction as that of the horizontally-oriented segments. Then, an offset grid 49 might be arranged with rows 48 and slanted columns 48a, as reflected in FIG. 30. (Compare FIG. 4 and associated discussion, above.) Because the direction of the slant is the dominant geometric vector component direction, according to the discussion above, one might choose to reduce the number of marking locations along that direction (i.e., increase row spacing) to reduce the number of target focus point sweeps needed to sweep the entire grid, while still preserving legibility.

It has been discovered that, through the analytical processes described, one can determine that one of the column or row spacings in the grid may be different, i.e., greater than, than the other of the column or row spacings.

Next, a sweep direction is chosen via identification of either (1) the sweep direction that requires the smaller number of turnarounds to sweep all locations in the grid, i.e., the smaller number of times that the beam guiding equipment is required to reverse the direction of the beam target focus point as it executes successive sweeps of all rows or columns of the selected grid; this will be the direction along which the greater of the number of rows, or number of columns, would be traversed, during a sweep of the target focus point; and/or (2) the direction along which the greatest average number of laser pulses (effecting marks) are to be emitted during the sweep. In the latter case, the laser system may be controlled such that, when a series of consecutive void locations is encountered along a single sweep path, the sweep is accelerated beyond the designated constant surface velocity over the series of void locations, then decelerated back down to the designated constant surface velocity when the next location in the path to be marked is approached. In this manner, where one or more series of a plurality of consecutive void locations are present between mark locations along a sweep path, the time for that sweep may be reduced by more rapid traversal of the sweep over the void locations. This is explained in greater detail in, e.g., U.S. application Ser. No. 17/963,214.

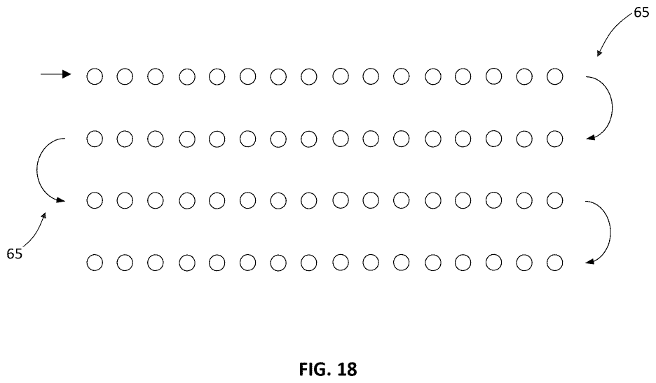

The steps described above may be illustrated with reference to FIGS. 11-16. These figures are expanded views of small portions of a larger grid that may encompass a given print assignment. The diagonal arrangements of marks shown in FIGS. 11-16 might be, for example, a portion of the slanted leg portion of the capital letter “N”. Referring to FIGS. 11 and 12, a hypothetical example of square sample portion of a grid, that might encompass a print area on an article, may be arranged wherein column and row repeat distances 51 and 57 of the grid locations, are equal, such that the individual locations are equally spaced along the directions of the rows and columns. The unit cells, reflected in FIGS. 11 and 12, as defined above, are square. The numeric density, i.e., spacing, of mark/void locations (54, 56) in the grid is the same in both directions. The number of rows in the small portion shown is equal to the number of columns. In this example, the number of turnarounds 65 of the beam target focus point sweep necessary (seven) is the same, regardless of whether the chosen sweep direction is vertical or horizontal (with respect to the figures). Thus, if sweep velocity is the same in either direction, marking/time efficiency is substantially the same, regardless of the choice made for assignment of the beam target focus point sweep direction. If the diagonal configuration of marks shown in the grid locations is a portion of, e.g., an image or alphanumeric character (such as the letter “N”), the number of beam sweeps through the grid necessary to impart the marks is the same, regardless of whether the sweeps are made along columns or along rows, i.e., regardless of the chosen sweep direction—as is the required number of turnarounds 65—in the example shown, seven.

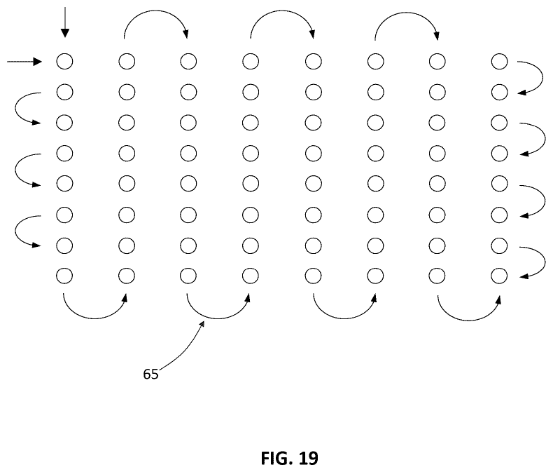

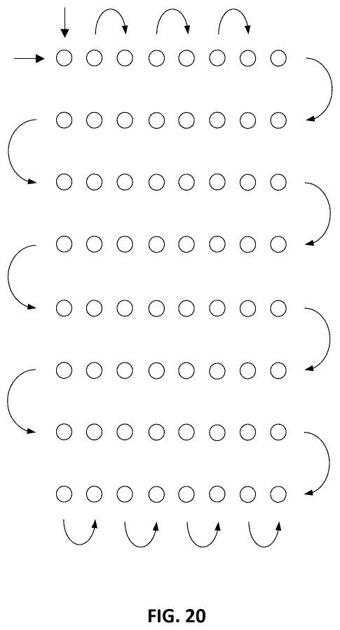

It has been discovered, however, that it may be a rare situation in which grid locations cannot be reduced in numeric density (i.e., spaced at relatively greater distances apart) along one direction of the grid rows/columns as compared with the other (perpendicular or oblique) direction of the grid rows/columns, while still retaining satisfactory legibility and/or resolution/appearance quality. For example, beginning with the square sample portion of a grid illustrated in FIGS. 11 and 12, for a given print assignment, one can likely learn, through experimentation and/or analysis such as described above, that the number of grid locations may be reduced, in the hypothetical non-limiting example illustrated, halved, by removing grid locations and making the repeat distance along one direction twice as much as the repeat distance along the other (perpendicular or oblique) direction. Experimentation and/or analysis may reveal permissible reduction of the number of grid locations along a vertical direction as reflected in FIGS. 13 and 14, or along a horizontal direction, as reflected in FIGS. 15 and 16. In the hypothetical examples illustrated, upon analysis, it may be determined whether the approach reflected in FIGS. 13 and 14, or alternatively, the approach reflected in FIGS. 15 and 16, yields the more satisfactory result, with respect to legibility and quality of appearance of, e.g., alphanumeric characters. Reduction of the number of grid locations needed for a given print assignment, via increase in a repeat distance of rows or columns, will necessarily decrease the number of rows or columns, i.e., increasing spacing between columns means fewer columns; increasing spacing between rows means fewer rows.

Following this step of minimizing the number of grid locations needed for the print assignment, the sweep direction is selected as the one in which the fewest turnarounds 65 are required to sweep the entire grid encompassing the print assignment. Among the hypothetical examples shown in FIGS. 13 and 14, choosing the sweep direction to be horizontal with respect to the figure, i.e., along rows, will provide for faster printing because fewer turnarounds 65 (three rather than seven) are required (FIG. 13). Among the hypothetical examples shown in FIGS. 15 and 16, choosing the sweep direction to be vertical with respect to the figure, i.e., along columns, will provide for faster imprinting because fewer turnarounds 65 (three rather than seven) are required (FIG. 15).

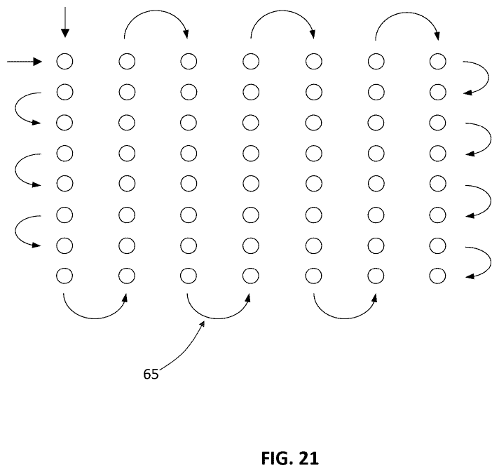

FIGS. 17 and 18 depict two hypothetical examples of rectangular portions of larger grids that might encompass a print area on an article.

FIG. 17 reflects a determination that the repeat distance along horizontal rows may be greater than the repeat distance along vertical columns, while retaining desired levels of legibility and/or quality of appearance. The sweep direction is selected as the vertical direction, because this requires the lesser number of turnarounds 65 (three) as the laser beam target focus point is guided to sweep the entire grid.

FIG. 18 reflects a determination that the repeat distance along vertical columns may be greater than the repeat distance along horizontal rows, while retaining desired levels of legibility and/or quality of appearance. The sweep direction is selected as the horizontal direction, because this requires the lesser number of turnarounds 65 (three) as the laser beam target focus point is guided to sweep the entire grid.

From the foregoing, it can be appreciated that, to make most efficient, therefore fastest, use of the pulsed laser system to mark within a grid, it may be desired to choose a sweep direction by which the beam target focus point moves over the greatest possible number of grid locations to be processed (by effecting a mark, or leaving a void, in each location) in a single sweep, on average for all sweeps. During a sweep, the pulsing laser, gating system and guidance equipment are processing locations in the grid by emitting pulses, to effect marks on the article markable surface, or withholding pulses, to leave voids, along the sweep direction. During turnaround travel, the system is not engaged in processing locations on the grid, but rather, the beam guidance equipment (including the X-Y galvo set) is executing deceleration along the sweep direction from constant sweep velocity, shift of the beam target focus point along the perpendicular or oblique direction to the next adjacent sweep path, reversing direction of sweep, and accelerating along the sweep direction back to constant surface velocity in the reversed direction, in preparation to sweep the target focus point along the next, adjacent sweep path—this turnaround is, in effect, unproductive motion and unproductive time.

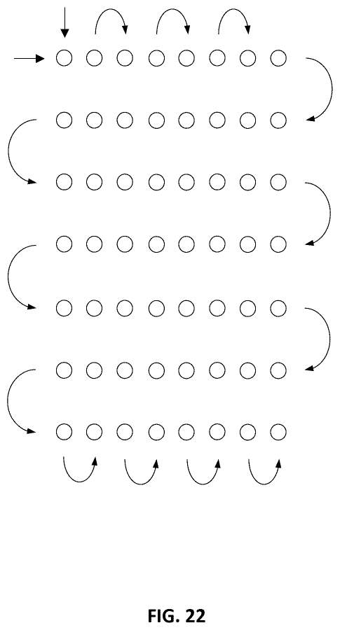

Depending upon the shape and dimensions of the print area and other factors, it is theoretically possible that increasing the repeat distance of columns or rows for a given grid shape (i.e., reducing the density of mark locations along one of the horizontal or vertical directions) will result in a grid requiring the same number of turnarounds regardless of whether the sweep direction is horizontal or vertical. FIGS. 19 and 20 illustrate examples, in which seven turnarounds are required regardless of choice of sweep direction. In the portions of grids shown, the number of turnarounds required to sweep all rows and columns of the grid (seven) is the same, regardless of whether the sweep direction is vertical or horizontal.

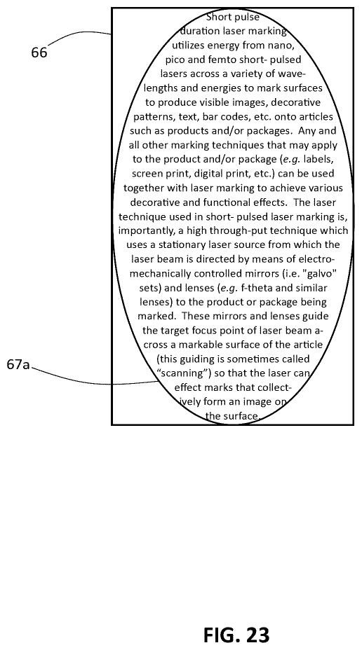

Nevertheless, a reduction in the number of rows or columns of the grid required to mark the article with satisfactory legibility and appearance quality will reduce the number of marking sweeps required, and thereby reduce cycle time. FIGS. 21 and 22 depict portions of grids similar to those of FIGS. 19 and 20, except that one column (FIG. 21) or row (FIG. 22) of grid locations has been removed. As may be appreciated from comparison of FIGS. 21 and 22 to FIGS. 19 and 20, where the number of rows or columns of marking locations is decreased via lesser numeric density and/or greater repeat distance spacing along either the horizontal or vertical directions, the number of turnarounds 65 required for sweeping in the perpendicular direction may be decreased as well (in the examples shown, from seven to six).

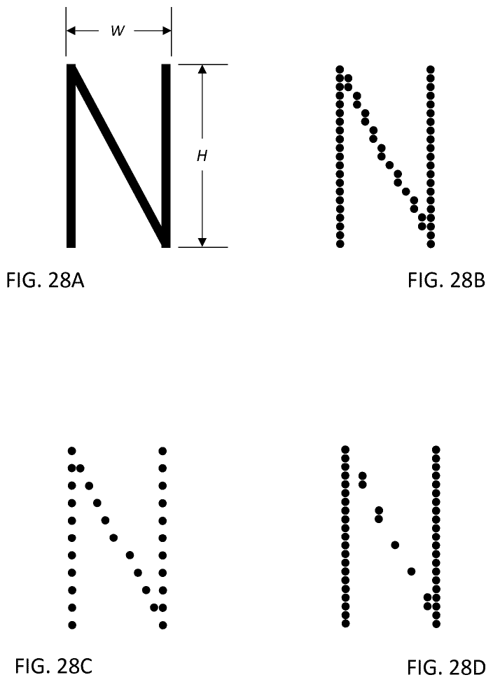

Depending upon the particular print assignment presented, it may be possible in some examples for the most efficient sweep direction to differ from both the column and row direction orientations in the grid. Referring to FIG. 27, to illustrate, a particular print assignment may require an arrangement of marks that can be swept most efficiently along a direction oblique to the orientation directions of both the columns and rows of the grid. In the illustration in FIG. 27, the number of turnarounds is only two, when the sweep direction is selected to follow the orientations of identifiable series of marks in which the greatest average number of marks per sweep may be effected, rather than one of the directions of orientation of the rows and columns. As described further below, the grid need not be laid out to effect sweep over unprinted or “white” space to the outside of the printed material. Thus, the grid may have a conforming outline 67 that delimits the required length of each sweep and thereby avoids unnecessary sweep time.

To summarize, for a given print assignment and layout thereof, including alphanumeric text and/or graphic image(s) as they are intended to appear on an article, without intending to be bound by theory, it is believed that identifying the most time-efficient marking process involves one or more of the following steps:
Where a substantial or majority portion of the area to be printed will be occupied by verbal and/or numerical information conveyed via alphanumeric characters, determine the dominant geometric vector direction of the alphanumeric characters in the print assignment;
Determine the minimum numeric density of marks needed along a first direction (i.e., maximum allowable mark repeat distance in the first direction), to provide satisfactory legibility and quality of appearance of the text and/or graphic image(s) in the print assignment;
Determine the minimum numeric density of marks needed along a second direction orthogonal or oblique to the first direction (i.e., maximum allowable mark repeat distance in the second direction), to provide satisfactory legibility and quality of appearance of the text and/or graphic image(s) in the print assignment;
Arrange a grid of locations encompassing the print assignment, wherein rows and columns of the grid define individual locations having repeat distances along the first and second directions corresponding to the respective maximum allowable mark repeat distances along the respective first and second directions, determined in the preceding two steps;
Select the beam target focus point sweep direction as that which will enable sweep of the beam target focus point over all of the locations in the grid, with the fewest turnarounds and/or enable sweep of the beam target focus point over all of the locations in the grid with the maximum average number of pulses/marks effected per sweep.

Additionally, unprinted or “white” space extending uninterruptedly along an entirety of a print area along a chosen sweep direction (for example, unmarked spaces between horizontal lines of alphanumeric text, when the sweep direction is horizontal) may be skipped over, i.e., it is not necessary to sweep the target focus point over such space, since no marks are required in that space along the sweep direction. Similarly, the grid need not be rectangular. The grid may be arranged to bound and encompass only the print assignment as presented, and X-Y galvo set controlled such that it sweeps paths only within the boundary of the print assignment.

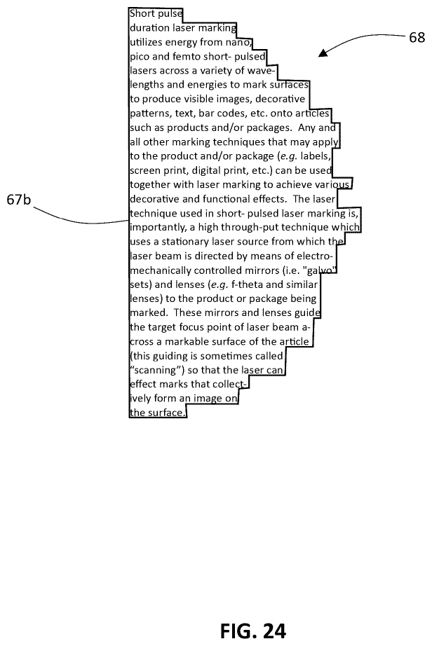

To illustrate, referring to FIG. 23, a non-limiting example of a print assignment may include a passage of alphanumeric text arranged within a generally elliptical boundary, for example, as shown. If the grid utilized were to have a rectangular outline 66, the target focus point would have to be swept along the entirety of the rectangle area, including the white space outside the actual text. This would unnecessarily consume time required to sweep over the white space. To eliminate this wasted time, the grid may be arranged with a generally conforming outline 67a, that, in the non-limiting example depicted, traces an elliptical boundary about the text.

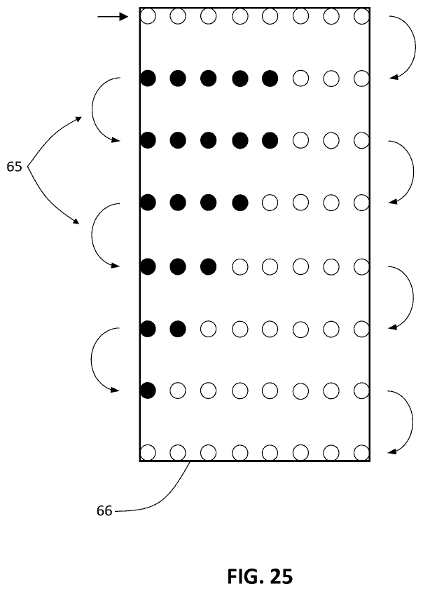

Similarly, referring to the text arrangement shown in FIG. 24, rather than creating a grid outline generally circumscribing the text arrangement, the grid may be arranged with a specifically conforming outline 67b that eliminates a need to for the target focus point to be swept over white space preceding or following each line of text. The specifically conforming outline 67b may include any appropriate number and shape of print assignment conformities 68 that closely outline the material in the print assignment as arranged.

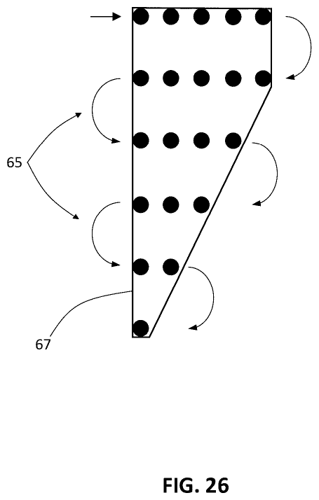

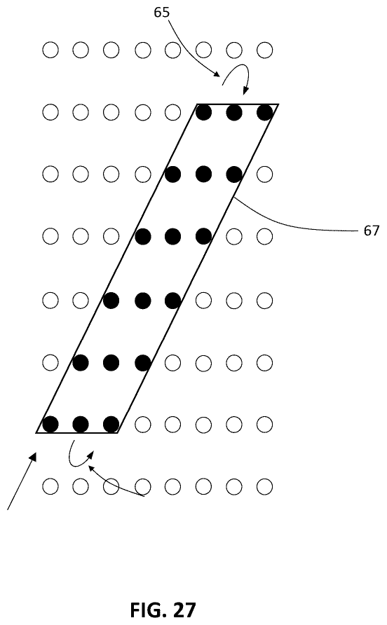

The effects of skipping over regions of white-space extending through the print area along the sweep direction, and use of such a conforming grid outline, may be appreciated with reference to FIGS. 25 and 26, which illustrate the effects at a closer level. In both figures, the arrangement of mark locations (shown as black spots) is the same. In FIG. 26, however, the number of turnarounds 65 required, and the number of rows to be swept, have both been reduced by elimination of grid locations in white space regions, as has the total required sweep distance. Eliminating unneeded sweep and turnarounds in this manner can reduce cycle time.

### Laser-Marking Backgrounds and Foregrounds of Machine-Readable Codes

It is believed that, prior to the discoveries described herein, articles having surfaces constituted by medium-to-darkly-colored polymeric material, and articles such as hollow containers constituted by highly translucent or transparent polymeric material, did not readily lend themselves to direct laser-mark imprinting of the information-containing, darkly-colored elements of machine-readable codes of acceptable quality, according to ISO/IEC standards. Darkly-colored materials may not provide sufficient background contrast with relatively dark bars or other shapes constituting information-containing elements of a machine-readable code, to provide sufficient reliable readability. Translucent or transparent polymer materials may allow too much incident laser light energy to pass therethrough, rather than be absorbed by a well-defined and limited volume of material proximate the impingement site, to effect clear, sharp marking. For these reasons, to date, machine-readable codes have been applied to such articles via applied labels or wrappers that have been pre-printed with the codes. Alternatively, a substantially white or light-colored ink or other coating may be applied to the surface to be marked to provide a reflective light-colored background. The ink or coating may be formulated to be laser-sensitive such that it may be darkened at laser impingement sites, such that the information-containing elements may be marked on the area bearing the ink or coating.

It has been learned, however, that laser-marking alone may be used to efficiently and successfully imprint machine-readable codes of acceptable quality on such articles, thereby avoiding a need for applied labels, wrappers or coatings, and the costs and process steps associated therewith, to effect application of a machine-readable code to an article.

One or more laser marking systems as described herein may be used. Referring to illustrative but non-limiting examples depicted in FIGS. 31A-31C, a laser marking system may be configured to create a pattern of one or more lightened background regions 81, constituting the background portion(s) of the machine-readable code, directly on the surface of the article. Lightening may be effected by one or more of foaming, bleaching, oxidation, altered crystallization, ablation and/or combinations thereof. The same laser-marking system, or a second laser-marking system, may be configured to create a pattern of darkened foreground shapes 82, which constitute the code and contain the encoded information. Darkening may be effected by one or more of carbonization, pyrolysis, reduction, a chemical change to an additive to the polymer(s) constituting the article surface, and/or combinations thereof.

Without intending to be bound by theory, it is believed that, for articles with markable surfaces of translucent or transparent container walls constituted predominantly of PET, one or both of alteration of crystallization and foaming may be most effective and efficient for lightening, while carbonization may be most effective and efficient for imparting a suitably contrasting darkening of the material. It is believed that, for articles with markable surfaces of translucent or transparent container walls constituted predominantly of polyolefins such as polypropylene and/or polyethylene, foaming may be most effective and efficient for lightening, while carbonization, also, may be most effective and efficient for imparting a suitably contrasting darkening to the material.

Where a single laser marking system is used, marking/imprinting of the respective background region(s) and foreground shapes of the desired machine-readable code may be effected at or proximate a material surface in successive operations, wherein the laser marking system is programmed to mark first one of the regions or shapes, then the other, and may be operated at differing settings to effect respective lightening or darkening of the material via differing manners of physical or chemical alteration. Alternatively, there are lasers available that can be programmed to vary pulse energy from one pulse to the next, thereby changing settings from one pulse to the next. Thus, a suitably-selected laser system may be configured to mark both the lightened and darkened areas of the entirety of the background and information-containing code shapes, in a single pass. Where two or more laser marking systems are used, marking/imprinting of the respective background region(s) and foreground shapes of the desired machine-readable code may be performed substantially simultaneously or in successive operations, wherein a first laser marking system is programmed to mark one of the regions by effecting a physical or chemical alteration at or proximate the material surface in a first manner, and a second laser marking system is programmed to mark the other of the regions by effecting a physical or chemical alteration at or proximate the material surface in a second manner, wherein the two systems may be operated at differing settings such as differing pulse durations, differing pulse energies and/or differing laser wavelengths to effect respective lightening or darkening. As contemplated herein, using such techniques, it becomes unnecessary to pre-apply a label or wrapper, or ink or other composition to a material surface of the article, to provide a white or light-colored background for the machine-readable code.

The quality of machine-readable codes and the acceptability/sufficiency thereof may be assessed with reference to ISO/IEC standards. For 1D machine-readable codes (e.g., bar codes), in many circumstances it may be desired that the laser-marked code exhibit an overall symbol grade of 1.5 or greater, based on verification according to the most current revision of ISO/IEC 15416 (as of the first filing date of the present application, 2016). For 2D machine-readable codes (e.g., 2D barcodes, matrix codes), in many circumstances it may be desired that the laser-marked code exhibit a grade equal to or greater than 1 based on verification according to the most current revision of ISO/IEC 15415 (as of the first filing date of the present application, 2011). It will be appreciated that the grade of a machine-readable code that is imprinted on polymeric material(s) via laser marking can be met and/or improved via the techniques described herein.

### Darkly-Colored Polymers

Without intending to be bound by theory, it is believed that inducing foaming in a surface of polymeric material via laser impingement may be a preferable technique for laser marking/laser imprinting a lightened background region on a surface constituted by darkly pigmented (or otherwise darkly-colored) and nearly or completely opaque polymer-based compositions. It is believed that this is true for surfaces constituted predominately by materials including polypropylene (PP), polyethylene (PE), and PET. For purposes herein, a material surface is “darkly-colored” if it exhibits a CIELAB L* value equal to or less than 50. (Note, for purposes herein, the term “darkly-colored” is not meant to be interchangeable with other terms such as “darker-colored.”) The portions that are foamed will exhibit a substantial lightening in coloration that can be suitable for a background region component of a machine-readable code.

For a darkly-colored polymer material with a markable surface constituted by PP, PE and/or PET, it may suffice in some circumstances to laser-mark/imprint only a background region of a machine-readable code, leaving defined foreground shapes, embodying the encoded information, untreated, such that the original color of the material is visible and contrasts with adjacent areas of the marked background region, which surround and define the foreground shapes of the code. In these circumstances, the relatively darker color of the untreated polymer composition in the foreground shapes and the lightened color of the laser-marked background region may exhibit sufficient contrast with each other to make the combination of the background region(s) and foreground shapes reliably readable by an optical reader. In a sense, this technique involves laser-mark-imprinting a “negative” of the desired machine-readable code on the darkly-colored surface material. The applicability of this technique may depend upon the wavelength of incident light that is generated by the type of optical reader that is expected to be used to read the machine-readable code. For example, if the desired machine-readable code to be marked will contain the encoded information in darker foreground shapes against a lighter-colored background, the pre-marking color of the surface material needs to be more absorptive than reflective of the incident light wavelength(s) generated by the contemplated optical scanner. In a specific example, if the contemplated optical scanner will generate visible red light (as many types of scanners currently in use do), a surface material having a red color or red-proximate color may be unsuitable for this technique, because it may excessively reflect red light rather than absorb it. By contrast, a surface material that is black, medium-to-dark gray (for example, L*≤75; −5≥a* and b*≤5) or medium-to-dark blue (for example, L*≤50; a*≤30; b*≤−75) may be suitable for this technique in many circumstances.

For examples in which laser-marking to effect both lightened and darkened regions is desired, generally, as the color of the untreated material surface ranges away from bright white (L*=100, a* and b* both=0), it becomes increasingly more desirable to impart lightened regions via laser marking. Similarly, as the color of the untreated material surface ranges farther from black (L*=0, a* and b* both=0), it becomes increasingly more desirable to impart darkened regions via laser marking, wherein contrasting lightened and darkened regions together make up the machine-readable code. As noted, lightening of the background region may be effected by, e.g., foaming or alteration of crystallization, but note, also, the other lightening techniques identified herein. Darkening of the foreground shapes of the code may be effected by one or more of carbonization, pyrolysis, reduction, a chemical change to an additive to the polymer(s) constituting the article surface, and/or combinations thereof. The suitable technique(s) employed may depend upon the composition of the polymer or other material(s) constituting the surface to be marked, the composition of pigmenting material(s) and/or laser absorption additives included therein, and the nature and extent of their reactivity to differing frequencies of laser light that may be applied.

Accordingly, in some examples, where an unmarked surface material prior to any laser marking treatment exhibits CIELAB L* values wherein both a* and b* are equal to or less than −70, or equal to or greater than 70 (via pigmentation, tinting or other coloration means), depending upon the particular coloration/hue and L* value, it may be desirable to laser-mark/imprint lightened area(s) to constitute the lighter-area component(s) of the machine-readable code. This may be particularly true when the L* value for the untreated surface material is less than 75, or less than 50.

Similarly, in some examples, where an unmarked surface material prior to any laser marking treatment exhibits CIELAB L* values wherein both a* and b* are equal to or greater than −70 or equal to or less than 70 (via pigmentation, tinting or other coloration means), depending upon the particular coloration/hue and L* value, it may be desirable to laser-mark/imprint darkened area(s) to constitute the darker-area component(s) of the machine-readable code. This may be particularly true when the L* value for the unmarked surface material is greater than 50.

### Translucent Polymers

Without intending to be bound by theory, it is believed that inducing foaming in polymeric surface material via laser impingement may be preferable for laser marking/laser imprinting a lightened background region on surfaces such as outsides of container walls constituted by translucent compositions, particularly highly translucent and substantially transparent compositions. In such materials, for purposes of enabling and/or enhancing speed and efficacy of laser marking, it may be desired that the material include one or more laser absorption additives. For purposes of lightening by foaming in a background region of a desired machine-readable code, it may be desired that the additive(s) serve to absorb heating energy at or closely proximate the location of laser impingement to effect rapid melting and evaporation of polymer material. Foaming via laser marking not only effects lightening of coloration, but also effects and/or substantially increases opacification of translucent materials. Lightening of coloration and opacification make the surface material more reflective of incident light that would be directed at the code by an optical scanner. Thus, foaming is a technique for providing a substantially opaque, relatively lighter-colored region constituting a component of a machine-readable code.

For purposes of darkening by reduction to mark/imprint, e.g., relatively darkened foreground shapes containing the encoded information, it may be desired that the additive(s) be reactive to the wavelength of laser light applied, such that they will rapidly darken upon impingement by an incident laser light beam, or alternatively, effectively and rapidly absorb heat to effect carbonization.

### Color Contrast, Foreground and Background Areas of Machine-Readable Codes

Working within these general conditions, without intending to be bound by theory, it is believed that, generally, a machine-readable code constituted of respective lighter and darker, contrasting regions desirably exhibits one and preferably both of the following color contrast characteristics. These characteristics may be manipulated and adjusted via the techniques described herein:
ΔE*_{1,2} is equal or greater than 20, preferably 22, more preferably 25, even more preferably 30, and still more preferably 35; and equal to or less than 200, preferably equal to or less than 220, and more preferably equal or less than 240;
ΔL*_{1,2} is equal to or greater than 20, preferably 22, more preferably 25, even more preferably 30, and still more preferably 35; and equal to or less than 60, preferably equal to or less than 70, and more preferably equal or less than 80, wherein the lighter region(s) exhibit a first set of CIELAB L*₁, a*₁, b*₁ values, and the darker region(s) exhibit a second set of CIELAB L*₂, a*₂, b*₂ values, and:

$$Δ {E}_{1 , 2}^{*} = {[ {( {L}_{2}^{*} - {L}_{1}^{*} )}^{2} + {( {a}_{2}^{*} - {a}_{1}^{*} )}^{2} + {( {b}_{2}^{*} - {b}_{1}^{*} )}^{2} ]}^{0.5} ;$$

$$Δ {L}_{1 , 2}^{*} = {[ {( {L}_{2}^{*} - {L}_{1}^{*} )}^{2} ]}^{0.5} ;$$

and
A Contrast value is 20-50, or more preferably 20-60.

Due to the relatively small size of features and details of machine-readable codes, it may be difficult to isolate representative samples of only background areas and/or only foreground areas thereof, for color measurement. Accordingly, for purposes herein, values for ΔL* and ΔE* may be measured using the ΔL*/ΔE* and Contrast Measurement Methods described and/or referred to below.

### Translucent Polymer Containers—Color of Contents

In some examples, it may be desired to mark machine-readable codes on containers that are constituted of one or more polymer(s) that form a translucent or transparent container wall, and will contain product that has a relatively light color. One particular example may be a translucent bottle or jug to contain milk. Another particular example may be a translucent polymer jar, tub or container type containing powdered laundry detergent that is substantially white in color. In such examples, it may be feasible to laser-mark only the relatively darker-colored component of the desired machine-readable code (such as the dark bars of a bar code) on the container (either prior to or following filling with product). When the container is filled with the light-colored product, the combination of the translucent wall material and the light-colored product may result in a sufficiently light color suitable for forming the lighter-colored component of a machine-readable code, and thus the darker-colored marked areas over the lighter-colored surrounding region may become readable by an optical scanner. The light-colored product may sufficiently reflect back incident light from the optical scanner, through the translucent or transparent container, while the relatively darker-colored marked areas absorb the incident light. In such examples, it may be desired that the surface and wall of the container to be marked be both translucent and have effectively minimal coloration prior to marking. Herein, “minimal coloration” means that the subject surface and wall have CIELAB have a* and b* values each greater than −10 and less than 10, more preferably greater than −5 and less than 5, and an L* value greater than 75, more preferably greater than 90, when measured over a white background.

Depending upon the color/wavelength of the incident light provided by the contemplated optical scanner, with regard to container contents, the converse may be true in some examples as well. Where the contents of the container are dark in color, it may be feasible in some examples to laser-mark only the relatively lighter-colored component of the desired machine-readable code (such as the light background regions of a bar code, surrounding the dark bar portion) on the container (either prior to or following filling with product). Examples of products that are dark in color might include liquids like grape juice and black coffee. When the container is filled with the dark-colored product, the combination of the translucent wall material and the dark-colored product may result in a sufficiently dark color suitable for forming the darker-colored component of a machine-readable code, and thus the darker-colored unmarked areas against a lighter-colored, marked surrounding region may become readable by an optical scanner. As discussed above, lightening and opacification of a surface constituted of one or more polymer(s) may be effected via a variety of techniques including foaming and/or alteration of crystallization. The lightened, opacified region imparted via laser marking may sufficiently reflect back incident light from the optical scanner, while incident light might not be reflected back through the translucent container wall and darker-colored container contents.

### Additional Laser Marking Rate Improvement Measures

As discussed, use of techniques contemplated herein can enable laser marking of articles faster and with more precision than prior processes. Existing raster processes are relatively slow, but relatively accurate, while vector laser marking processes are relatively faster and accurate at low speeds but relatively imprecise at high speeds, resulting in imprinted characters or other marked images that may have poor appearance quality, poor human legibility and/or poor machine readability (e.g., for bar codes). Raster and vector are different graphic file types that require different modes of laser processing. The main differences between the techniques of each type involve the movement of the galvos that guide the laser beam, and in the parameters used.

The vector path typically is slower for images because of the multiple fixed short start and stop points that require the galvo set to spend time accelerating to a user set maximum surface velocity (determined by the repeat distance multiplied by the pulse repetition rate) and the length of the vector distance. Lengthy vector distances allow the vector pulsed laser system to reach its maximum surface velocity, while shorter vector distances have the pulsed laser system constantly accelerating and decelerating and never reaching the maximum surface velocity, resulting in longer marking cycle times.

The vector process is also less precise than the CV-bitmap process at high speeds, due to the acceleration/de-acceleration of the galvos guiding the laser beam. Specifically, the location of each laser mark must be communicated from a computer driven software to the laser marking apparatus and such communication must be updated during the marking of the predetermined pattern, for example, as the laser beam traverses a given row. Typical update frequencies for this communication are ˜10 μs, so a laser outputting pulses with a repetition rate of 100 kHz would allow for an update in the communication for each individual location in the grid. This is also true of raster laser marking processes, which may further include variation of the pulse power for each pulse as a means of achieving grayscale (e.g., dithering). As the velocity of the laser beam movement across the surface of the article increases, repetition rates of greater than 100 kHz are required to achieve the desired mark spacing, and each update from the software must now communicate the location of multiple laser marks (or voids/non-marks). While the calculations can be performed nearly instantaneously, it is believed that in the extremely fast time-domains of high-speed laser marking, the galvos cannot respond as quickly, and the accelerate/de-accelerate profile of the vector process results in a significant number of misplaced marks within a given row, versus the constant surface velocity technique contemplated herein.

FIG. 6B depicts the effect of running a vector-type process at high speed when marking text involving alphanumeric characters and the misplacement of marks within a row. The figure shows misplaced marks resulting from marking initiating too early or too late, so that the outline of the alphanumeric character is jagged and the overall appearance is blurred, of unacceptable appearance quality, and potentially illegible (e.g., one cannot distinguish an “8” from an “0”).

In contrast, the process and resulting markings contemplated herein can be imparted by a constant surface velocity (CV) bitmap path. The CV-bitmap laser marking process allows for increased speed and increased precision because there are no start and stop points within a row or column to be marked, but rather, a user-defined maximum surface velocity (again, the repeat distance multiplied by the pulse repetition rate) that is constant while as the beam sweeps the row or column and emits or withholds marking pulses. Moreover, the pulsed laser system contemplated herein can increase beam guidance speed when the beam is not marking over a relatively long distance (relative to the repeat distance in the sweep direction). For example, if there is a distance of 2-3 mm (or more) between centers of marks in one row, the pulsed laser system can accelerate to a greater speed without losing accuracy; otherwise, during marking, the laser beam is moved at a constant surface velocity while pulsing. This is yet another reason the marking systems and techniques of this disclosure are faster and more accurate than prior systems and techniques.

Relatively smaller galvo sets (i.e., sets having relatively lower mass mirrors) have less inertia and thereby enable relatively greater acceleration to reach this user-defined maximum surface velocity. One can tune these galvo sets to relatively high acceleration values that allow the mirrors to reach their desired angular velocity in a lesser amount of time. Interestingly, these values can be tuned specifically for bitmap processing at higher values, as compared to vector processing. Additionally, in vector laser control software there is a maximum marking surface velocity limitation set such that the laser marks are close to their desired commanded position. As one increases the maximum surface velocity threshold in vector processing, the laser pulse target points exhibit more error with respect to their intended positions. In CV-bitmap marking mode, since the surface velocity (e.g. both the angular velocity of the mirrors and the surface velocity of the laser beam sweep) is constant during the marking process, one can increase the maximum surface velocity threshold significantly achieving an overall lower marking cycle time as compared with vector processing, and still maintain firing of pulses at the target positions intended.

The mass of X-Y mirrors and mechanical limitations of associated galvo motors impose mechanical limitations on acceleration and deceleration of the target focus point required during, e.g., turnarounds. However, it has been learned that these limitations may be substantially mitigated via extension of the focal length and working distance. As focal length is increased, the surface velocity of the target focus point is proportionately increased: other variables being held constant, as focal length increases, less angular movement of the mirror(s) is required to cause the target focus point to sweep along a same distance along the focal plane. Also, as focal length is increased, slower angular movement of the mirror(s) is required to cause the target focus point to sweep at a same surface velocity, and slower angular deceleration and acceleration of the mirrors is required to cause the target focus point to execute the same turnaround (other variables being held constant). Additionally, the size of the field of view is increased with increase of the focal length. As an article is moved within the field of view of a laser marking system by a conveyor at a given speed, a larger field of view provides a greater window of time for the system to execute a larger and/or more detailed print assignment, while the article to be imprinted is being conveyed within the field of view.

Thus, increasing focal length allows one to (a) increase target focus point sweep velocity/surface velocity; (b) execute turnarounds faster; and (c) take advantage of a larger field of view, within the limits of the chosen X-Y galvo set. Increasing the size of the field of view facilitates executing a print assignment of larger surface area in a single process and/or via a single laser configuration, without the need for dividing the print assignment among more than one laser configuration. Utilizing equipment currently available and configured as described herein, the field of view resulting from increasing focal length may range from 40,000 mm² to 2,250,000 mm², and thereby may be large enough to execute a print assignment via sweep of an associated grid having an area 400 mm² to 800 mm², or to 2,000 mm², or to 4,000 mm², or to 8,000 mm², or to 12,000 mm², or to 16,000 mm², or even to 20,000 mm², at conveying speeds contemplated herein.

For purposes contemplated herein, and to enjoy the advantages identified above, it may be desired to configure a laser marking system with a focal length of at least 330 mm, preferably at least 1,000 mm and more preferably at least 2,000 mm, or even more preferably at least 3,000 mm, within limits of lens that are or may be available. At any given constant surface sweep velocity, reducing angular velocity required for an X-Y galvo set to execute a turnaround in the sweep path enables choosing a tuning of certain earlier types of galvo sets that provides a faster turnaround time. In contrast, newer scanners like Scanlab EXCELLISCAN and INTELLISCAN IV can automatically change the turnaround time based on scan velocity. For both of these cases, longer focal length lenses significantly reduce the turnaround time component of the process time which is made up of constant velocity, white space accelerations/decelerations and turnarounds.

Focal length may be increased via selection and use of a lens with a greater specified focal length. However, as the focal length associated with a chosen lens increases, spot size (diameter of the beam as most tightly focused in the focal plane of the lens) also increases. Increase of spot size decreases the amount of energy delivered by a beam pulse from a given laser, per unit surface area (fluence) on the target surface. Decrease of fluence reduces the efficacy of a laser beam pulse at marking the target surface, and may also reduce mark sharpness and precision.

To compensate, and thereby realize the advantages of increasing focal length as identified above, it has been learned that one may insert a beam expander in the laser beam path, preferably at a location upstream of the X-Y galvo set. With reference to FIG. 2A, this would be at a location between laser 20 and X-mirror 22. A beam expander 70 increases the diameter of the collimated beam 28. Increase of the diameter of the collimated beam that enters the lens 26 (which, as previously noted, may be an f-theta lens) reduces the diameter of spot size in the focal plane. Thus, fluence at focus point 29 in focal plane 29a may be increased by use of a beam expander, enabling effective use of a lens with a greater focal length and enjoyment of the advantages thereof, noted above, which are particularly beneficial when marking an article that is translating along a path on a conveyor.

The angular velocity of the X-Y galvo set mirrors are important to job cycle time as it relates directly to the laser beam's surface velocity across the article. The surface velocity of the laser beam is set by the angular velocity of the X-Y mirror pair and the specified focal length of the lens used.

surface velocity=galvo angular velocity (rad/sec)*focal length (mm)

In some examples, the surface velocity of the target focus point during a sweep along a given row or column may, with appropriate setup, be controlled by the X-galvo/mirror set. In this circumstance, job cycle time can be more dependent on the laser surface velocity in the sweep direction than in the perpendicular or oblique direction, and the X-galvo/mirror set may be chosen so as to be more responsive than the Y-galvo/mirror set. For example, the mirror on the X-galvo/mirror set may be chosen to be smaller (i.e., lower mass, smaller mirror size, lower inertia, higher acceleration motor capability) than the Y-galvo/mirror set. In the event a sweep direction is chosen for a particular print assignment that requires rotation of the galvo system to orient the X- and Y-mirrors correctly for the particular assignment, that may be accomplished during setup.

The usable surface velocities (sweep velocities) of the laser beam target focus point sweep across the focal plane in the current CV-bitmap process are much greater than those achievable with currently available laser marking processes such as raster and vector marking processes. Current processes typically exhibit surface velocity on the order of 8 m/s or less. The CV-bitmap process contemplated herein provides for surface velocities above 8 m/s, and further, surface velocities equal to or greater than 10 m/s, 15 m/s, 18 m/s, 22.5 m/s, 32.5 m/s, 45 m/s, 60 m/s, 90 m/s, or even 200 m/s, and are expected to go higher with improvements in pulse laser technology.

Control of the direction of the sweep path of the laser beam target focus point across the focal plane can also contribute to reduced cycle time. A conventional raster laser marking process sweeps the laser beam across rows in either of right-to-left or left-to-right progress directions, but not both (known as a “unidirectional” process), and at the completion of a row at one end, returns the beam to the other end of the next row in a manner analogous to that of a carriage return on a typewriter. In this way, subsequent rows can be easily registered (i.e., stacked) and grid locations can be aligned based on this consistent starting line. To eliminate the return distance travel and thereby reduce the time required to sweep each row (or column), the current CV-bitmap process uses a “bi-directional” process in which marking may be done in back-and-forth progress directions (e.g., sweep occurs left-to-right in a first row and right-to-left in a next row).

To keep the rows or columns of marking pulses aligned, the pulsed laser system may be programmed to incorporate a laser-on-adjust which is a delay function for each alternating row or column.

The laser-on-adjust is an element of the turnaround profile of the target focus point sweep path. The turnaround profile refers to the guidance path executed by the X-Y galvo set directing the target focus point path to shift and reverse direction proximate the ends of adjacent rows or columns (e.g. after a sweep processing a row left-to-right, decelerating from specified constant velocity to zero in the left-to-right sweep direction, shifting beam target focus point to the next row of the grid, and accelerating in the right-to-left sweep direction to specified constant velocity to sweep and mark the next row right-to-left). The laser is typically off (i.e., not emitting pulses) during the turnaround. The laser-on-adjust facilitates alignment of pulses and effected marks within adjacent rows or columns. For example, when the grid is a stacked grid, the laser-on-adjust ensures that the marks in adjacent rows remain stacked. If an offset grid is used, then the laser-on-adjust will help ensure that the grid remains offset, and that the amount of the offset remains sufficiently constant. The laser-on-adjust value may be determined experimentally, and generally, may vary with angular velocity of the galvo sets.

The profile of the turnaround of laser beam path after sweep of a row or column can also help reduce cycle time. As discussed previously, the laser beam focus is guided along the article surface by an X-Y galvo set, and the rate at which a galvo and mirror can accelerate and decelerate angularly is a known limitation to speed and accuracy of laser marking in other (e.g., vector) marking processes. The current CV-bitmap process helps overcome this limitation. The current CV-bitmap process does not affect acceleration or deceleration of the laser beam target focus point while the laser is emitting pulses (i.e., imparting marks on the article). Instead, the target focus point is only accelerated and decelerated while the laser is not pulsing, such as, for example, when the target focus point is skipping multiple voids (or even entire rows), or when the target focus point is being reversed and shifted at the completion of a row, in preparation to sweep and mark along a subsequent row. The turnaround profile may be symmetric or asymmetric. Given the high speeds at which the laser beam sweeps across the surface of the article, an asymmetric turnaround profile may be preferred.

As discussed, changing grid location spacing can affect cycle time. As discussed, spreading out the locations within the grid (i.e., increasing the row and/or column spacings) can enable a decrease of cycle time. Increasing the repeat distance along a sweep reduces cycle time in that the surface sweep velocity is a factor of the laser repetition rate and the repeat distance. Increasing the other of the row or column spacings can reduce cycle time by reducing the number of turnarounds that the galvo sets are required to execute, which may take up to 30-70 percent of the total cycle time at high surface velocities. In some examples, one might be able to reduce the column spacing and increase the row spacing to get an acceptably-similar quality image at a reduced overall cycle time. It has been discovered, that for any particular grid, reducing one of the row or column spacings-concurrently with leaving the other unchanged, or increasing it, can enable faster cycle time for a given print assignment.

As discussed, appropriate selection of row and column spacings and their ratio can contribute to laser marking legible small font text or images at high speed (i.e., low cycle time). Row and column spacing can also be important when marking images such as graphics, particularly when the image(s) include grayscale. Whereas the known process of raster marking creates grayscale by varying the energies of individual laser pulses, the CV-bitmap process instead runs too fast and does not vary these pulse energies individually. The CV-bitmap process may be used to emulate grayscale printing by appropriately spacing full energy pulses and resulting marks in appropriate patterns to impart a grayscale appearance.

In the laser marking process contemplated herein, the laser source may be kept stationary, and the laser beam may be guided by the pulsed laser system including a series of lenses and mirrors which are controlled by an algorithm, so as to execute the print assignment with relatively high speed. The algorithm is able to read a digital image of the desired print assignment (e.g. from a PDF file of the desired image) and translate the image to a suitable arrangement of marks, in locations within a grid, such as will provide a reproduction of the print assignment with satisfactory legibility and appearance quality on the subject article surface. Examples of a suitable lens/mirror systems and algorithms may currently be obtained from IPG Photonics, Oxford, Massachusetts, USA, or laser processing modules available from LasX Industries, Inc., White Bear Lake, Minnesota, USA.

### Packeting

One way the currently contemplated constant velocity (CV)-bitmap process can overcome the 10 μs limit update rate is to include multiple individual instructions in one packet of instructions to the pulsed laser system. That is, a packet may include individual instructions for each of a plurality of potential laser pulses at the pulsed laser's particular repetition rate, to pulse or not to pulse, in a single update that results in the laser emitting a pulse creating a mark, or omitting a pulse leaving a void. In such a process, each row may contain marked and unmarked locations according to the packet of instructions.

The constant velocity of the laser beam target focus point sweep provides that the sweep direction distance within these chains of multiple pulses (or withheld pulses) will remain consistent. Recalling that the target focus point sweep speed along the focal plane is determined as:

Repeat distance×repetition rate=surface velocity

increasing the repetition rate of the laser from 100 kHz to 200 kHz doubles the surface velocity, and thereby can contribute to reducing cycle-time.

Including multiple individual instructions in a single update can also be used to enhance the resolution and/or intricacy of detail of the printed image to be effected. While a laser marking process that includes only one pulse per update (i.e., employing the 10 μs update rate and a 100 kHz repetition rate laser) can produce intricacy to a single mark or void on the article markable surface corresponding with individual grid locations, such as:

$$mark - void - mark - void - mark - void$$

the same process employing a 200 kHz laser would have twice the target focus point sweep speed but could only produce such detail on the markable surface as:

$$mark - mark - void - void - mark - mark - void - void - mark - mark - void - void$$

The target focus point sweep speeds across the grid enabled by the CV-bitmap process contemplated herein are much faster than those achievable with currently available laser-marking processes such as raster and vector marking processes.

The packets of individual instructions defined herein may be communicated to the pulsed laser system at regular time intervals, such as every 10 μs. The packets of individual instructions defined herein contain pulse/no pulse information as described above but may also contain additional instructions in each packet. For example, a packet of information might include individual instructions related to position of the locations at which pulses will be directed. To increase the speed and accuracy of the overall pulsed laser marking process, it desirable to do two things. First, each packet of information should include the maximum number of individual instructions that the processor will allow, and second, the number of instructions related to pulses/no pulses, should be maximized with respect to other instructional information in the same packet.

To illustrate the packeting concepts contemplated herein, one might think of a packet as a vehicle such as a bus. There might be, for example, 2, 4, 8, 16, 32, 64 or more, seats on a given bus. Driving a bus with 16 seats from point A to point B, with only 4 people on board, is an inefficient use of the bus. Just as filling each of the 16 seats of the bus with a passenger, filling each packet of information with the maximum number of individual instructions that the processor will allow will increase efficiency.

The pulsed laser marking processes contemplated herein operate with a constant pulse repetition rate and a constant surface velocity when sweeping the laser beam target focus point over a given row or column of locations in the grid, with a brief deceleration/re-acceleration process at the turnaround following the end of the sweep of each row or column. During this turnaround process the laser is not marking; beam pulses are not being emitted. Further, the only reversal of direction occurs, again, beyond the end of each row or column. During the brief turnaround period, the packets of instructions may include a greater amount of positional information.

Similarly, constant surface velocity and constant repetition rate provide that the locations along a selected sweep direction locations are predetermined at the outset of the sweep informed by a packet. As such, with the exception of the beginning and end of each row, the packets of individual instructions may require only one positional instruction. The positional instruction may include X-, and Y-, and Z-components. (When sweeping a target focus point along a planar focal plane, the Z-component of the position information may be consistently zero).

Because the target focus point of the pulsed laser moves at constant surface velocity over marking locations along the focal plane, the end point of the sweep informed by one packet determines the beginning point for the next packet. Thus, the one individual instruction related to position serves the dual purpose of the end location for one packet and the beginning locations for the next. Velocity is defined as distance traveled divided by the time required to travel that distance. Each packet has a set time, and the one positional instruction tells the pulsed laser system how far to sweep the target focus point, which defines the speed. Thus, no additional instructions related to speed are required, which frees computational space (“seats” on the “bus”) for pulse/no pulse instructional information. This simplification of speed and position maximizes the number of individual instructions available, relating to mark and void. This speeds up the entire process and makes it more accurate. This level of efficiency for packet use cannot be achieved with the prior art process (i.e., raster, vector) that, for example, draw borders, and then fill in between the lines. Those prior art processes require additional information concerning speed and position, within each packet of information.

Thus, a markable surface of an article can be marked using a pulsed laser system to create image(s) constituted by a plurality of marks and voids on a markable article surface, at locations on the surface corresponding with locations laid out in a grid in the focal plane. The grid is made up of a plurality of locations disposed along an arrangement of substantially parallel rows and columns, wherein each location either receives a focused beam pulse, or not, resulting in a mark on the article surface corresponding with an associated location in the grid, or a void. Beam pulses from the pulsed laser system effect the marks, and absence of (or omission of) pulses leaves the voids. The pulsed laser system is controlled by a computing device that sends packets of instructions to the pulsed laser system, the packet of instructions comprising at least 2, preferably at least 4, more preferably at least 8, and even more preferably at least 16, or even at least 32 or at least 64 or more individual instructions, wherein each individual instruction informs the laser to emit a pulse that is directed and focused on the focal plane or not, imparting a mark or leaving void, respectively, on the article at locations corresponding with each location in the grid pattern. The packets of instructions may be provided to the pulsed laser system at a 10 μs update rate (in accordance with currently standard industrial communication protocols). It is contemplated that advances in technology will increase the update rate at which the packets may be provided to the pulsed laser system may in the future be less than 10 μs, or 7.5 μs, or 5 μs, or even 2.5 μs, but as best as currently understood, this is not currently the case.

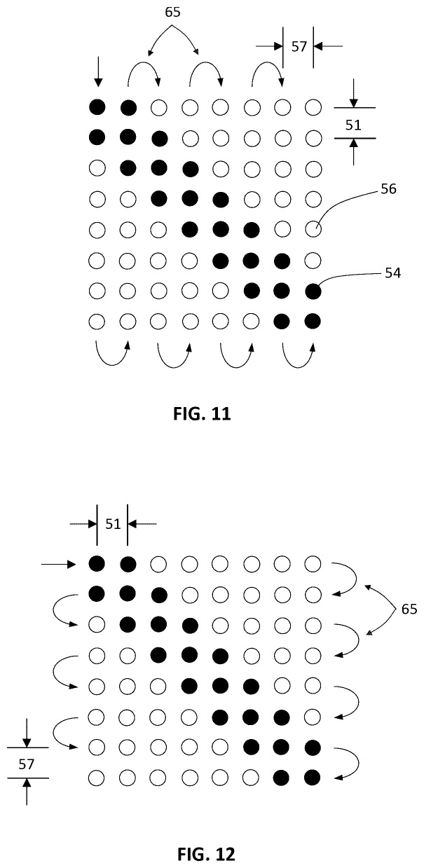

FIG. 7 is an example of one row of a grid pattern with packets P1, P2, P3 and P4 each containing 2 individual instructions to the pulsed laser system. P1 instructs the pulsed laser system to pulse twice, resulting in two marks. P2 instructs the pulsed laser system to not pulse twice, leaving two voids. P3 instructs the pulsed laser system to pulse once, then not pulse once, effecting one mark and leaving one void. P4 instructs the pulsed laser system to do the opposite of P3. This arrangement of marks and voids corresponding to locations in a grid pattern may be used to form any of a variety of images.

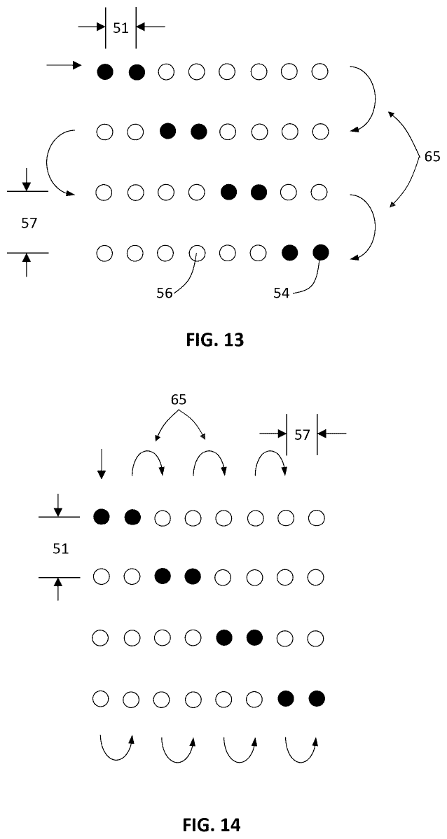

FIG. 8 is an example of one row of a grid pattern with packets P1, P2, P3 and P4 each containing 4 individual instructions to the pulsed laser system. P1 instructs the pulsed laser system to pulse three times and not pulse once, so as to effect three marks and one void. P2 instructs the pulsed laser system to pulse twice, then not pulse twice, effecting two marks and leaving two voids. P3 instructs the pulsed laser system to pulse once, not pulse, pulse again, then not pulse, effecting a mark-void-mark-void pattern. P4 instructs the pulsed laser system to not pulse three times then pulse once, effecting three voids and one mark.

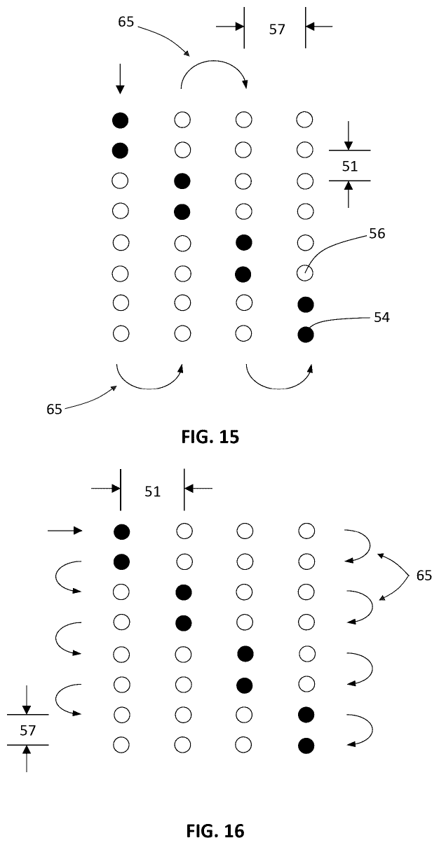

FIG. 9 is an example of one row corresponding with one row of a grid pattern with packets P1 and P2 each containing 8 individual instructions to the pulsed laser system. P1 instructs the pulsed laser system to pulse twice, not pulse, pulse, not pulse, pulse twice, and not pulse. P2 instructs the pulsed laser system to pulse eight times. Polygon scanners of the prior art can send two or more instructions to a pulsed laser system, but the instructions are all pulse, or all not-pulse. For example, a polygon scanner can send eight pulses and then eight no-pulse instructions, for a single update. These polygon scanners of the prior art cannot send individual instructions according to the present disclosure. Improved versatility is achieved by controlling each and every location with a pulse, or withheld pulse, as taught by the present disclosure. Images including alphanumeric characters, graphic images, logos, UPC codes, QR codes, and the like can be formed by marks effected on surfaces with improved speed and accuracy by utilizing the individual packeted instructions contemplated herein.

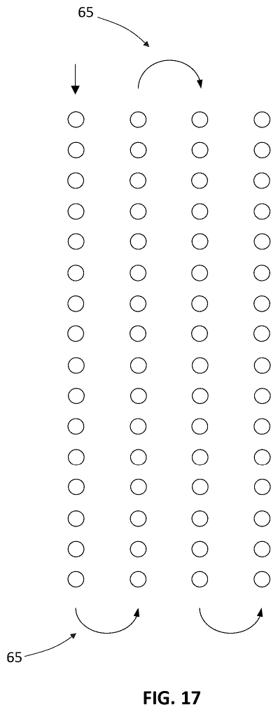

FIG. 10 is an example of one row of a grid pattern with packet P1 containing 16 individual instructions to the pulsed laser system. P1 instructs the pulsed laser system to pulse two times, then not pulse twice. This pattern is repeated three more times for a total of 16 individual instructions in one packet of information.

There is further provided herein a method of marking a markable surface using a pulsed laser system comprising the following steps. First, define an image to be formed by a plurality of marks and voids in a grid, the grid comprising a plurality of discrete locations disposed along a series of substantially parallel rows. Each location is to receive a laser beam pulse, or not, to leave either a mark or a void corresponding with the location. Then, effect the marks by pulsing the pulsed laser system, and leave the voids by not pulsing the pulsed laser system. The pulsed laser system is controlled by a computing device that sends packets of instructions to the pulsed laser system, the packet of instructions comprising 2, preferably 4, more preferably 8, and even more preferably 16 or more individual instructions. Each individual instruction informs the pulsed laser system to pulse or not to pulse, leaving a mark or a void, respectively, at each location on the article surface corresponding with each location in the grid pattern.

### Laser Marking/Laser Imprinting Articles in Motion

Via experimentation with the processes and equipment for laser marking articles described above, it has been discovered that the enhanced marking speed (without substantial compromise of precision and resolution) achievable thereby can enable laser marking articles while they are in, e.g., translating or even rotating motion, e.g., moving on a conveyor constituting a component of a manufacturing and/or packaging line. The hardware and software that controls the laser beam emission, direction, path and surface velocity may be programmed to continuously adjust the X-mirrors and/or Y-mirrors that direct the laser beam, along suitable directions and at a rate that continuously adjusts for the conveying path velocity and moving position of the articles on the conveyor. (Herein, “conveyor” means any equipment configured to convey or transport articles along a one-, two-, or three-dimensional path that extends for any measurable distance, within and/or through an operably effective field of view of the lens component of the laser system-herein, the “print window.”) It has been discovered that the laser system described herein may be adapted and programmed to execute laser marking on articles in motion on a conveyor without unacceptable distortion or loss of precision of the intended printed subject matter, as enabled by the relatively short time required for such marking, i.e., due to the rapid marking speed enabled by the equipment and methods described herein.

In the simplest examples including articles having curving/contoured surfaces to be imprinted, the conveying path, as the article passes through the print window of a stationary laser system including an f-theta or flat-field lens from which the directed beam emerges toward the target focus point, may be linear (i.e., purely translational, or one-dimensional). In such examples, as noted, it may be desired that the relative positioning of the path of the passing article and the lens from which the laser beam emerges, are selected and adjusted such that the focal plane of the lens, as the equipment is positioned, divides the difference between the shortest and longest distances between the surface of the article to be marked, and the lens, through the print window. (This is discussed further, above, with reference to FIG. 2B.) Such positioning may serve to minimize distortion and/or loss of clarity of the intended marked image and/or alphanumeric text, that can result from the laser beam pulse impinging on the article surface at a location that is in front of or behind the focal plane of the lens (i.e., where the laser beam spot is not most tightly focused).

In other examples that do not include an f-theta or flat field lens, the conveyor equipment and conveyor path may be configured such that the articles follow a two-dimensional arc path about or around the stationary laser system, specifically, about the location where the laser beam emerges from the lens. In such examples, the possibility for distortion of the intended print subject matter may be further reduced, because distance between the articles and the emergent location of the laser beam from the lens may be configured to be fixed, or less changeable, than would be the case with a linear conveyor path passing a stationary laser system.

In either of the approaches described above, for added purposes of simplicity of programming and minimization of possibilities for error in mark placement or distortion of intended print subject matter, it may be desired that the path speed of the articles on the conveyor be constant, or if it changes, it changes at a rate that does not overtake the update rate at which the encoder can keep abreast of the changes in path speed through the print window.

In other examples, in order to reduce the relative change of position between the laser system and the articles being marked as they move along an article path on the conveyor, the laser system may be mounted to its own conveying equipment so as to be simultaneously moved along a laser system path that is at least partially parallel and/or tracks the article conveying path, during the marking process. In some examples, one or more laser systems may be mounted on a rotating fixture, that moves the laser system(s) along a first arc path, and the article conveying equipment can be configured to convey the articles along a second arc path along which the articles and the laser system(s) move at similar angular velocities.

In other examples which in some circumstances may be advantageous where, for example, the desired marking is relatively dense (e.g., dense text material and/or densely-spaced markings to form high-resolution graphic images), or alternatively the print assignment has a relatively large surface area, marking of a pattern on a single article, moving on a conveyor, may be performed using a series of a plurality of stationary laser systems disposed along the conveying path. In such a configuration, a first laser system may be configured to mark a first portion of the desired pattern on the article; a second laser system may be configured to mark a second portion of the desired marking pattern on the article, and so on, wherein the respective laser systems are disposed and configured to perform their respective portions of the marking in a manner such that the respectively marked portions are coordinated and/or aligned to form the desired marking pattern as a coherent whole result. In effect, each portion of the print assignment is a separate print assignment, with respect to each of the laser systems.

In other examples, a series of a plurality of stationary laser systems may be configured in series along the conveying path to divide the task of marking the passing series of articles. To illustrate, for example, a first laser system may be configured and programmed to completely mark a first article moving through a first print window in which the first laser system operates; a second laser system disposed downstream of the first may be configured and programmed to completely mark a second article that has followed the first article on the conveyor and moves through a print window in which the second laser system operates, etc. In this manner, a plurality of laser systems in series may be configured to have print windows such that the plurality of laser systems are performing respectively complete marking operations on a plurality of moving individual articles simultaneously or during overlapping time periods, thereby enabling more rapid marking of articles passing by on a conveyor.

Rather than monitor movement and speed of the article itself, it may be deemed practical and most efficient to provide and utilize an encoder to monitor conveyor speed, and feed such data to the laser control system, to enable the system to adjust marking sweeps for the movement of the article and the speed thereof. In combination, it may be desirable that the conveyor include or be associated with a mechanism configured to prevent the article from moving in any manner, relative the components of the conveyor effect conveyance of the article within the field of view for marking. This helps ensure precise and accurate marking, without errors that may result from relative movement between the articles and the conveyor.

Although the features of marking method(s) described above may in some circumstances enable a producer to avoid a need to divide the task of executing a print assignment on articles in motion into two or more portions, to be performed by two or more laser systems, such an approach is not intended to be excluded. In examples in which the desired print assignment has a relatively large surface area and/or requires relatively high resolution (i.e., relatively high number of marks per unit surface area), it may remain desirable to divide the task of executing a print assignment on articles in motion into two or more portions, to be performed by two or more laser systems. Regardless, the features of marking method(s) described above can enable such processing to be accomplished with improved speed/cycle time.

Furthermore, the marking methods described herein may enable overall processing throughputs on packing, packaging, filling lines, bottle finishing lines and the like, including marking processes, of greater than about 25 articles per minute and/or greater than 50 articles per minute, and/or greater than 75 articles per minute, and/or greater than 100 articles per minute, and/or greater than 125 articles per minute, and/or greater than 150 articles per minute, and/or greater than 200 articles per minute, and/or greater than 250 articles per minute. Alternatively, the marking methods described herein may enable overall processing throughputs including marking processes on packing, packaging, filling lines, bottle finishing lines or the like of greater than about 25 articles per minute although less than about 2,500 articles per minute.

In addition to the foregoing, the disclosures of the following US patent applications are incorporated herein by reference, to the extent not inconsistent herewith: Ser. No. 17/963,214; Ser. No. 17/963,215; Ser. No. 17/987,893; Ser. No. 17/987,895; Ser. No. 18/128,341; Ser. No. 18/128,347; Ser. No. 18/128,356; Ser. No. 18/128,359; Ser. No. 18/631,142; and Ser. No. 63/664,355.

### Measurement Methods

### ΔL*and ΔE* Measurement Methods

To measure the ΔL* value of contrasting lighter-colored and darker-colored areas constituting a machine-readable code disposed on an article, a sample must be identified that includes the entirety of the machine-readable code to be analyzed. This can be done by visually locating the machine-readable code to be analyzed, preferably in an area of low curvature/surface contour or an area which can be urged into a flat configuration via applying pressure or using any suitably constructed frame on or about the sample. The sample is prepared by cutting out a portion of the article bearing the entirety of the machine-readable code. To obtain the sample, sharp scissors (or other suitable cutting tool that will not damage the sample itself) may be used to first cut a portion from the article including the entirety of the machine-readable code. For relatively soft plastic samples, a razor blade may be used to cut out and trim the sample down to the desired dimensions. The sample will be scanned and a region of interest (ROI) encompassing the entirety of the foreground shape components of the machine-readable code will be analyzed. The perimeter of the ROI encompasses the entirety of the foreground shape components (information-containing bars or other shapes) and included background (contrasting region(s) interposed among/between the foreground shapes). As shown in the examples in FIGS. 31A-31C, the perimeter of the ROI 83 (shown in dashed lines) has a rectangular shape that substantially precisely circumscribes and contains the entirety of the pattern of foreground shape components of the machine-readable code.

All samples should be evaluated over a white background. The 2856 Byko-chart Brushout 5DX card available from BYK-Gardner, Germany, or an equivalent having a spatially consistent appearance of L*>91, −5<a*<5, and −3<b*<3 is used for the white backing. The backing is placed on the opposite surface of the article from which the scan image will be collected. The sample is conditioned at about 23° C.±2° C. and about 50%±2% relative humidity for 2 hours prior to analysis.

A flatbed scanner capable of scanning a minimum of 24-bit color at 1200 dpi with manual control of color management (a suitable scanner is an Epson PERFECTION V750/V850 Pro from Epson America Inc., Long Beach CA, or equivalent) is obtained and calibrated, as set forth herein. The scanner is interfaced with a computer running color calibration software capable of calibrating the scanner against a color reflection IT8 target utilizing a corresponding reference file compliant with ANSI method IT8.7/2-1993 (suitable color calibration software is MONACO EZCOLOR or I1STUDIO available from X-Rite Grand Rapids, MI, or equivalent). The color calibration software constructs an International Color Consortium (ICC) color profile for the scanner, which is used to color correct an output image using an image analysis program that supports application of ICC profiles (a suitable program is PHOTOSHOP available from Adobe Systems Inc., San Jose, CA, or equivalent). The color-corrected image is then converted into the CIE L*a*b* color space for subsequent color analysis (a suitable image color analysis software is MATLAB version 9.12 available from The Mathworks, Inc., Natick, MA).

The scanner is turned on 30 minutes prior to calibration and image acquisition. Any automatic color correction or color management options included in the scanner software are turned off (de-selected). If the automatic color management cannot be disabled, the scanner is not appropriate for this application. The procedures recommended by the color calibration software are followed to create and export an ICC color profile for the scanner. The scanning surface should be free of dirt, dust, streaks, and any other image distorting elements.

A scan is taken that completely includes the ROI, and is imported into the image analysis software at 24-bit color with a resolution of at least 1200 dpi (approximately 47.2 pixels per mm) in reflectance mode. The ICC color profile is assigned to the image producing a color corrected sRGB image. This calibrated image is saved in an uncompressed format to retain the calibrated R, G, B color values, such as a TIFF file, prior to analysis.

The sRGB color calibrated image is opened in the color analysis software such as MATLAB which converts it into CIE L*a*b* color space. This is done as follows: First, the SRGB data is scaled into a range of [0, 1] by dividing each of the values by 255. Second, the sRGB channels (denoted with upper case R, G, B), or generically “V” are linearized (denoted with lower case r, g, b), or generically “v” as the following operation is performed on all three channels (R, G, and B):

$$\begin{matrix}V ∈ \{ R , G , B \} \\ v ∈ \{ r , g , b \} \\ v = \{ \begin{matrix}\frac{V}{12.92} if V \leq 0.04045 \\ \begin{matrix}{( \frac{V + 0.055}{1.055} )}^{2.4} & otherwise\end{matrix}\end{matrix} \}\end{matrix}$$

The linear r, g, and b values are then multiplied by a matrix to obtain the XYZ Tristimulus values according to the following formula:

$$[ \begin{matrix}X \\ Y \\ Z\end{matrix} ] = [ \begin{matrix}0.4124 & 0.3576 & 0.1 \; 805 \\ 0.2126 & 0.7152 & 0.0722 \\ 0.0193 & 0.1192 & 0.9505\end{matrix} ] [ \begin{matrix}r \\ g \\ b\end{matrix} ]$$

The XYZ Tristimulus values are rescaled by multiplying the values by 100, and then converted into CIE 1976 L*a*b* values as defined in CIE 15:2004 section 8.2.1.1 using D65 reference white.

The CIE L* image is analyzed within the ROI. Additionally, the a*, b*, or any sRGB image can be used if appropriate. Optionally, a Principal Component Analysis can be used to generate the most appropriate image to demonstrate maximum reflectance difference. A threshold is determined to separate the highest and lowest values of the machine-readable code. The threshold can be determined from a histogram of the pixels or an automated technique such as Otsu method (implemented as the multithresh function in MATLAB). The histogram should present 2 peaks caused by the high and low markings. The minimum value in the valley between the two peaks will be the threshold. An average high value is determined by averaging all the pixel values greater than the threshold and is the L* value characteristic of the relatively light area of the machine-readable code. An average low value is determined by averaging all the pixel values less than or equal to the threshold and is the L* value characteristic of the relatively dark area of the machine-readable code. The ΔL* value reported is the difference between the average high L* value and the average low L* value.

Where it is desired to obtain a ΔE* value of the machine-readable code, a method suitable as will be understood by those of skill in the art of color measurement, may be employed.

### Contrast Measurement Method

After performance of the steps described in the immediately preceding section, above, an accumulative histogram with integer bins from 0 to 100 is generated from the CIE L* image. The accumulative histogram Y values are divided by the total number of pixels. This creates an Accumulative Percentage Histogram. A “Bin5%” value is recorded as the first bin starting from 0 that exceeds 5% on the Accumulative Percentage Histogram. A “Bin95%” value is recorded as the first bin starting from 0 that exceeds 95% on the Accumulative Percentage Histogram. The Contrast measure is the difference between “Bin95%” and “Bin5%”.

### Method for Overall Bar Code Symbol Grade

For verification of linear bar codes, 7 verification parameters (decode, symbol contrast, minimum reflectance, minimum edge contrast, modulation, defects, and decodability) specified by ISO/IEC15416-1 are measured by use of an ISO/IEC compliant barcode verifier such as the Axicon 15500 (Axicon Auto ID Limited, Oxfordshire, UK). “Bar codes” are synonymous with the term “symbols” as defined in ISO/IEC15416-1. For each of these parameters, a grade from 0 to 4 is assigned per ISO/IEC15416-1 where 0 represents failure and 4 represents the highest quality. At least 10 scans which collect the reflectance profile across the full width of the bar code are measured using an ISO/IEC-compliant barcode verifier. The scan reflectance profile grade for each scan reflectance profile shall be the lowest grade of any parameter evaluated for that profile. An overall bar code symbol grade is computed by the arithmetic mean of each of the scan reflectance profile grades. The overall bar code symbol grade is reported to the nearest 0.1. For linear barcode symbols, the measurements may be taken using any combination of ISO/IEC recommended aperture diameter, wavelength of light, and angle of incident light.

For verification of two-dimensional bar code symbols including two-dimensional multi-row bar code symbols and two-dimensional matrix symbols, grading is performed as per ISO/IEC15415 by use of an ISO/IEC compliant 2D barcode symbol verifier such as the Axicon 15500 (Axicon Auto ID Limited, Oxfordshire, UK). Each parameter receives a grade from 0 to 4 where 0 represents failure and 4 represents the highest quality. The parameter having the lowest grade becomes the overall grade for the 2D symbol. For 2-dimensional barcode symbols, the measurement may be taken using any combination of ISO/IEC recommended aperture diameter, wavelength of light, and angle of incident light.

In view of the foregoing disclosure, the following non-limiting examples are contemplated:

### A. Product

1. An article of manufacture, comprising a surface constituted of a material, wherein at least a portion of the surface bears a marked machine-readable code, the code comprising a pattern of marking and comprising relatively darker-colored areas abutting or substantially adjacent to relatively lighter-colored areas; and wherein:
the material in the lighter-colored areas has been physically or chemically altered in a first manner, as compared to unmarked portions of the surface adjacent to the marked machine-readable code; and
the material in the darker-colored areas is unaltered, or has been physically or chemically altered in a second manner, as compared to the material in the lighter-colored areas;
wherein the first and second manners of physical or chemical alteration differ from each other.

2. The article of example 1 wherein the material in the darker-colored areas has been physically or chemically altered in the second manner.

3. The article of either of the preceding examples wherein the darker-colored areas constitute foreground shapes that contain encoded information, and the lighter-colored areas constitute background region(s).

4. The article of either of examples 1 or 2 wherein the lighter-colored areas constitute foreground shapes that contain encoded information, and the darker-colored areas constitute background region(s).

5. The article of any of the preceding examples wherein the material is constituted predominantly of one or more polymers.

6. The article of example 5, wherein the one or more polymers predominantly comprise a polymer selected from the group consisting of polypropylene (PP), polyethylene (PE) and polyethylene terephthalate (PET), and combinations thereof, and preferably PET.

7. The article of either of examples 5 or 6 wherein the alteration in the lighter-colored areas comprises foaming, bleaching, oxidation, altered crystallization, etching, ablation and/or combinations thereof, and preferably foaming, altered crystallization or a combination thereof, at or proximate the material surface.

8. The article of any of the examples 5-7 wherein the alteration in the darker-colored areas comprises carbonization, pyrolysis, reduction, a chemical change to an additive to the one or more polymers, and/or combinations thereof, and preferably carbonization, reduction or a combination thereof, at or proximate the material surface.

9. The article of any of examples 5-8 wherein the one or more polymers comprise an additive selected from the group consisting of titanium dioxide (TiO₂), titanium dioxide coated substrates such as mica, titanium sub-oxides, titanium nitride, zinc oxide, zinc sulfide, cadmium sulfide/selenide, ultramarines, tin oxides, antimony tin oxide (ATO), ATO coated substrates such as mica, Sb2O₃, indium oxide, indium tin oxide (ITO), doped metal nitrides, metal carbides, metal borides, tungsten oxides, doped tungsten oxides including hydrogen, cesium, sodium, and potassium tungsten bronzes, carbon black, graphene, graphitic carbon, graphene oxide, nano-graphite, lanthanum hexaboride, bismuth oxide, bismuth vanadate, iron oxides including hematite, magnetite and goethite, iron oxide coated substrates such as mica, cobalt and chromium oxides, mixed metal oxides, metal phosphates including copper phosphate, effect pigments, zero valent metals such as iron, aluminum, tungsten and copper having particle size distributions across the nano and micron ranges, pearlescent pigments, organic pigments including anthanthrone, anthraquinone, Benzimidazolone, BONA lakes, Mono and Diazo chemistries, pyrdiketopyrrolopyrrole (DPP), napthol chemistries, perylene, perinone, Quinacridone, Quinophthalone, phthalocyanines, indanthrone, isoindoline, metal complexes, napthols, and mixtures thereof, and combinations thereof.

10. The article of example 9 wherein the additive comprises one or a combination of aluminum, antimony tin oxide (ATO), tungsten oxide, titanium nitride, indium tin oxide, indium oxide, and carbon black.

11. The article of any of examples 5-10, wherein the article is a container having at least a section of container wall that is translucent.

12. The article of any of examples 5-11, wherein the article is a container having at least a section of container wall that is translucent, and the container contains a liquid product.

13. The article of any of examples 1˜4 wherein the material is constituted predominantly of a metal or metal alloy.

14. The article of any of the preceding examples, wherein:
the lighter-colored areas exhibit a first set of CIELAB values;
the darker-colored areas exhibit a second set CIELAB values; and
the first and second sets of CIELAB values differ such that ΔL* between them is equal to or greater than 20; and equal to or less than 60, preferably equal to or less than 70, and more preferably equal or less than 80.

15. The article of any of the preceding examples, wherein:
the lighter-colored areas exhibit a first set of CIELAB values;
the darker-colored areas exhibit a second set CIELAB values; and
the first and second sets of CIELAB values differ such that ΔE* between them is equal to or greater than 20; and equal to or less than 200, preferably equal to or less than 220, and more preferably equal or less than 240.

16. The article of any of the preceding examples, wherein the lighter-colored areas and the darker-colored areas exhibit a Contrast of 20-50, more preferably 20-60.

17. The article of any of the preceding examples wherein the code comprises a one-dimensional barcode.

18. The article of example 17 wherein the code exhibits an overall symbol grade of 1.5 or greater, based on verification according to the ISO/IEC15416.

19. The article of any of the preceding examples wherein the code comprises a two-dimensional barcode.

20. The article of any of the preceding examples wherein the code comprises a matrix code.

21. The article of either of examples 19 or 20 wherein the code exhibits a grade equal to or greater than 1, based on verification according to ISO/IEC15415.

22. The article of any of the preceding examples wherein the material overlays at least one base material constituting the article.

23. The article of any of the preceding examples wherein one or both the background region(s) and foreground shapes have features imparted to the material via absorption of laser energy.

24. An article of manufacture, comprising a surface of material comprising one or more polymers, wherein at least a portion of the surface bears a marked machine-readable code, the code comprising a pattern of marking comprising relatively darker-colored areas abutting or substantially adjacent to relatively lighter-colored areas;
wherein the lighter-colored areas exhibit a first set of CIELAB values;
wherein the darker-colored areas exhibit a second set of CIELAB values;
wherein the first and second sets of CIELAB values differ such that ΔL* between them is equal to or greater than 20; and equal to or less than 60, preferably equal to or less than 70, and more preferably equal or less than 80; and
wherein the lighter-colored areas have features imparted by absorption of laser energy.

25. An article of manufacture, comprising a surface of material comprising one or more polymers, wherein at least a portion of the surface bears a marked machine-readable code, the code comprising a pattern of marking comprising relatively darker-colored areas abutting or substantially adjacent to relatively lighter-colored areas;
wherein the lighter-colored areas exhibit a first set of CIELAB values;
wherein the darker-colored areas exhibit a second set of CIELAB values;
wherein the first and second sets of CIELAB values differ such that ΔE* between them is equal to or greater than 20; and equal to or less than 200, preferably equal to or less than 220, and more preferably equal or less than 240; and
wherein the lighter-colored areas have features imparted by absorption of laser energy.

26. The article of either of examples 24 or 25, wherein the lighter-colored areas and the darker-colored areas exhibit a Contrast of 20-50, more preferably 20-60.

27. The article of any of examples 24-26 wherein the darker-colored areas have features imparted by absorption of laser energy.

28. The article of any of examples 24-27 wherein the darker-colored areas constitute foreground shapes that contain encoded information, and the lighter-colored areas constitute background region(s).

29. The article of any of examples 24-28 wherein the lighter-colored areas constitute foreground shapes that contain encoded information, and the darker-colored areas constitute background region(s).

30. The article of any of examples 24-29 wherein the material is constituted predominantly of one or more polymers.

31. The article of example 30, wherein the one or more polymers predominantly comprise a polymer selected from the group consisting of polypropylene (PP), polyethylene (PE) and polyethylene terephthalate (PET), and combinations thereof, and preferably PET.

32. The article of either of examples 30 or 31 wherein the alteration in the lighter-colored areas comprises foaming, bleaching, oxidation, altered crystallization, etching, ablation and/or combinations thereof, and preferably foaming, altered crystallization or a combination thereof, at or proximate the material surface.

33. The article of any of the examples 30-32 wherein the alteration in the darker-colored areas comprises carbonization, pyrolysis, reduction, a chemical change to an additive to the one or more polymers, and/or combinations thereof, and preferably carbonization, reduction or a combination thereof, at or proximate the material surface.

34. The article of any of examples 30-33 wherein the one or more polymers comprise an additive selected from the group consisting of titanium dioxide (TiO₂), titanium dioxide coated substrates such as mica, titanium sub-oxides, titanium nitride, zinc oxide, zinc sulfide, cadmium sulfide/selenide, ultramarines, tin oxides, antimony tin oxide (ATO), ATO coated substrates such as mica, Sb2O₃, indium oxide, indium tin oxide (ITO), doped metal nitrides, metal carbides, metal borides, tungsten oxides, doped tungsten oxides including hydrogen, cesium, sodium, and potassium tungsten bronzes, carbon black, graphene, graphitic carbon, graphene oxide, nano-graphite, lanthanum hexaboride, bismuth oxide, bismuth vanadate, iron oxides including hematite, magnetite and goethite, iron oxide coated substrates such as mica, cobalt and chromium oxides, mixed metal oxides, metal phosphates including copper phosphate, effect pigments, zero valent metals such as iron, aluminum, tungsten and copper having particle size distributions across the nano and micron ranges, pearlescent pigments, organic pigments including anthanthrone, anthraquinone, Benzimidazolone, BONA lakes, Mono and Diazo chemistries, pyrdiketopyrrolopyrrole (DPP), napthol chemistries, perylene, perinone, Quinacridone, Quinophthalone, phthalocyanines, indanthrone, isoindoline, metal complexes, napthols, and mixtures thereof, and combinations thereof.

35. The article of example 34 wherein the additive comprises one or a combination of aluminum, antimony tin oxide (ATO), tungsten oxide, titanium nitride, indium tin oxide, indium oxide, and carbon black.

36. The article of any of examples 30-35, wherein the article is a container having at least a section of container wall that is translucent.

37. The article of any of examples 30-36, wherein the article is a container having at least a section of container wall that is translucent, and the container contains a liquid product.

38. The article of any of examples 24-29 wherein the material is constituted predominantly of a metal or metal alloy.

39. The article of any of examples 24-38, wherein the code comprises a one-dimensional barcode.

40. The article of any of examples 24-38, wherein the code comprises a two-dimensional barcode.

41. The article of any of examples 24-40, wherein the code comprises a matrix code.

42. The article of any of examples 24-41, wherein the material overlays at least one base material constituting the article.

43. The article of any of the preceding examples wherein the article is a container at least partially filled with a water-based liquid or fluid.

### B. Process/Method

1. A process for imprinting a desired machine-readable code onto or proximate a surface of an article, comprising the steps of:
providing an article comprising a surface constituted of a material;
positioning the article within one or more effective fields of view of one or more laser marking systems, wherein each laser marking system comprises a pulsed laser and a pair of laser-guiding mirrors;
causing the one or more laser marking systems to effect physical or chemical alteration of the material in a first manner in first regions of the desired code, to result in a relative lightening of color at or proximate the surface, and thereby result in relatively lighter-colored areas abutting or substantially adjacent second regions of the desired code.

2. The process of example 1 further comprising the step of causing the one or more laser marking systems to effect physical or chemical alteration of the material in a second manner within the second regions of the desired code, to result in a relative darkening of color at or proximate the surface, and thereby result in relatively darker-colored areas, wherein the darkening of color is effected by physical or chemical alteration of the material in a second manner, wherein the first and second manners of alteration differ from each other.

3. The process of either of the preceding examples wherein the first regions constitute foreground shapes that contain encoded information, and the second regions constitute background region(s).

4. The process of any of the preceding examples wherein the second regions contain constitute foreground shapes that contain encoded information, and the first regions constitute background region(s).

5. The process of any of the preceding examples wherein the material is constituted predominantly of one or more polymers.

6. The process of example 5, wherein the one or more polymers predominantly comprise a polymer selected from the group consisting of polypropylene (PP), polyethylene (PE) and polyethylene terephthalate (PET), and combinations thereof, and preferably PET.

7. The process of either of examples 5 or 6 wherein the alteration in the lighter-colored areas comprises foaming, bleaching, oxidation, altered crystallization, etching, ablation and/or combinations thereof, and preferably foaming, altered crystallization or a combination thereof, at or proximate the material surface.

8. The process of any of the examples 5-7 wherein the alteration in the darker-colored areas comprises carbonization, pyrolysis, reduction, a chemical change to an additive to the one or more polymers, and/or combinations thereof, and preferably carbonization, reduction or a combination thereof, at or proximate the material surface.

9. The process of any of examples 5-8 wherein the one or more polymers comprise an additive selected from the group consisting of titanium dioxide (TiO₂), titanium dioxide coated substrates such as mica, titanium sub-oxides, titanium nitride, zinc oxide, zinc sulfide, cadmium sulfide/selenide, ultramarines, tin oxides, antimony tin oxide (ATO), ATO coated substrates such as mica, Sb2O₃, indium oxide, indium tin oxide (ITO), doped metal nitrides, metal carbides, metal borides, tungsten oxides, doped tungsten oxides including hydrogen, cesium, sodium, and potassium tungsten bronzes, carbon black, graphene, graphitic carbon, graphene oxide, nano-graphite, lanthanum hexaboride, bismuth oxide, bismuth vanadate, iron oxides including hematite, magnetite and goethite, iron oxide coated substrates such as mica, cobalt and chromium oxides, mixed metal oxides, metal phosphates including copper phosphate, effect pigments, zero valent metals such as iron, aluminum, tungsten and copper having particle size distributions across the nano and micron ranges, pearlescent pigments, organic pigments including anthanthrone, anthraquinone, Benzimidazolone, BONA lakes, Mono and Diazo chemistries, pyrdiketopyrrolopyrrole (DPP), napthol chemistries, perylene, perinone, Quinacridone, Quinophthalone, phthalocyanines, indanthrone, isoindoline, metal complexes, napthols, and mixtures thereof, and combinations thereof.

10. The process of example 9 wherein the additive comprises one or a combination of aluminum, antimony tin oxide (ATO), tungsten oxide, titanium nitride, indium tin oxide, indium oxide, and carbon black.

11. The process of any of examples 5-10, wherein the article is a container having at least a section of container wall that is translucent.

12. The process of any of examples 5-11, wherein the article is a container having at least a section of container wall that is translucent, and the container contains a liquid product.

13. The process of any of examples 1-4 wherein the material is constituted predominantly of a metal or metal alloy.

14. The process of any of the preceding examples, wherein:
the first regions exhibit a first set of CIELAB values;
the second regions exhibit a second set CIELAB values; and
the first and second sets of CIELAB values differ such that ΔL* between them is equal to or greater than 20; and equal to or less than 60, preferably equal to or less than 70, and more preferably equal or less than 80.

15. The process of any of the preceding examples, wherein:
the first regions exhibit a first set of CIELAB values;
the second regions exhibit a second set CIELAB values; and
the first and second sets of CIELAB values differ such that ΔE* between them is equal to or greater than 20; and equal to or less than 200, preferably equal to or less than 220, and more preferably equal or less than 240.

16. The process of any of the preceding examples, wherein the first regions and the second regions exhibit a Contrast of 20-50, more preferably 20-60.

17. The process of any of the preceding examples wherein the code comprises a one-dimensional barcode.

18. The article of any of the preceding examples wherein the code comprises a two-dimensional barcode.

19. The process of any of the preceding examples wherein the code comprises a matrix code.

20. The process of any of the preceding examples wherein the material overlays at least one base material constituting the article.

21. The process of any of the preceding examples wherein the article is a container and is at least partially filled with a water-based liquid or fluid prior to the positioning step.

22. The process of any of the preceding examples further including a marking throughput of greater than about 25 articles per minute and less than about 2,500 articles per minute.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.” Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments contemplated herein have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An article of manufacture, comprising a surface of a material comprising one or more polymers, wherein at least a portion of the surface bears a marked machine-readable code, the code comprising a pattern of markings comprising darker-colored areas substantially adjacent to lighter-colored areas;
wherein the lighter-colored areas exhibit a first set of CIELAB values;
wherein the darker-colored areas exhibit a second set of CIELAB values;
wherein the first and second sets of CIELAB values differ such that ΔL* between them is equal to or greater than 20; and equal to or less than 80; and
wherein the lighter-colored areas have features imparted by absorption of laser energy.

2. The article of claim 1, wherein the code comprises a two-dimensional barcode comprising a matrix code and the code exhibits a grade equal to or greater than 1, based on verification according to ISO/IEC 15415.

3. The article of claim 1, wherein the code comprises a one-dimensional barcode and exhibits an overall symbol grade of equal to or greater than 1.5, based on verification according to ISO/IEC 15416.

4. The article of claim 1, wherein the lighter-colored areas constitute foreground shapes that contain encoded information and the darker-colored areas constitute a background region.

5. The article of claim 1, wherein the darker-colored areas constitute foreground shapes that contain encoded information and the lighter-colored areas constitute a background region.

6. The article of claim 1, wherein the one or more polymers are selected from polypropylene (PP), polyethylene (PE), polyethylene terephthalate (PET), and/or combinations thereof.

7. The article of claim 1, wherein the one or more polymers comprise an additive selected from antimony tin oxide (ATO), tungsten oxide, titanium nitride, indium tin oxide (ITO), indium oxide, carbon black, and/or combinations thereof.

8. The article of claim 7, wherein the darker-colored areas comprise carbonization, pyrolysis, reduction, a chemical change to an additive, and/or combinations thereof.

9. The article of claim 1, wherein the article is a container comprising a wall, wherein least a section of the container wall is substantially translucent.

10. The article of claim 9, wherein the container contains a water-based fluid.

11. An article of manufacture, comprising a surface of a material comprising one or more polymers, wherein at least a portion of the surface bears a marked machine-readable code, the code comprising a pattern of markings comprising darker-colored areas substantially adjacent lighter-colored areas;
wherein the lighter-colored areas exhibit a first set of CIELAB values;
wherein the darker-colored areas exhibit a second set of CIELAB values;
wherein the first and second sets of CIELAB values differ such that ΔL* between them is equal to or greater than 20 and equal to or less than 80; and
wherein both the lighter-colored areas and darker-colored areas have features imparted by absorption of laser energy; wherein the lighter-colored areas comprises foaming, bleaching, oxidation, altered crystallization, etching, ablation and/or combinations thereof and wherein the darker-colored areas comprises carbonization, pyrolysis, reduction, a chemical change to an additive to the one or more polymers, and/or combinations thereof.

12. The article of claim 11, wherein the one or more polymers comprise an additive chosen from titanium dioxide (TiO2), titanium dioxide coated substrates, titanium sub-oxides, titanium nitride, zinc oxide, zinc sulfide, cadmium sulfide/selenide, ultramarines, tin oxides, antimony tin oxide (ATO), ATO coated substrates, Sb2O3, indium oxide, indium tin oxide (ITO), doped metal nitrides, metal carbides, metal borides, tungsten oxides, doped tungsten oxides including hydrogen, cesium, sodium, and potassium tungsten bronzes, carbon black, graphene, graphitic carbon, graphene oxide, nano-graphite, lanthanum hexaboride, bismuth oxide, bismuth vanadate, iron oxides including hematite, magnetite and goethite, iron oxide coated substrates such as mica, cobalt and chromium oxides, mixed metal oxides, metal phosphates including copper phosphate, effect pigments, zero valent metals such as iron, aluminum, tungsten and copper having particle size distributions across the nano and micron ranges, pearlescent pigments, organic pigments including anthanthrone, anthraquinone, Benzimidazolone, BONA lakes, Mono and Diazo chemistries, pyrdiketopyrrolopyrrole (DPP), napthol chemistries, perylene, perinone, Quinacridone, Quinophthalone, phthalocyanines, indanthrone, isoindoline, metal complexes, napthols, and/or combinations thereof.

13. The article of claim 12, wherein the additive comprises one or a combination of aluminum, antimony tin oxide (ATO), tungsten oxide, titanium nitride, indium tin oxide, indium oxide, and/or carbon black.

14. The article of claim 11, wherein the first and second sets of CIELAB values differ such that ΔL* between them is equal to or greater than 20 and equal to or less than 60.

15. The article of claim 11, wherein the code comprises a two-dimensional matrix code and exhibits a grade equal to or greater than 1, based on verification according to ISO/IEC 15415.

16. An article of manufacture, comprising a surface of a material comprising one or more polymers, wherein at least a portion of the surface bears a marked machine-readable code comprising darker-colored areas substantially adjacent lighter-colored areas,
wherein the lighter-colored areas exhibit a first set of CIELAB values and the darker-colored areas exhibit a second set of CIELAB values that differ such that a Contrast is 20-50;
wherein both the lighter-colored areas and the darker-colored areas have features imparted by absorption of laser energy, the lighter-colored areas comprising foaming and/or altered crystallization at or proximate the material surface and the darker-colored areas comprising carbonization, pyrolysis, reduction, a chemical change to an additive to the one or more polymers, and/or a combination thereof at or proximate the material surface; and
wherein the one or more polymers comprise an additive selected from antimony tin oxide (ATO), tungsten oxide, titanium nitride, indium tin oxide (ITO), indium oxide, carbon black, and/or combinations thereof.

17. The article of claim 16, wherein the article is a container comprising a wall, wherein at least a section of the container wall is substantially translucent.

18. The article of claim 17, wherein the container contains a liquid product.

19. The article of claim 16, wherein the code comprises a two-dimensional matrix code and exhibits a grade equal to or greater than 1, based on verification according to ISO/IEC 15415.

20. The article of claim 16, wherein the material overlays at least one base material constituting the article.
